(19) United States
(12) Patent Application Publication
(10) Pub. No.: US 2013/0322546 A1
(43) Pub. Date: Dec. 5, 2013

(54) STREAM GENERATION APPARATUS, STREAM GENERATION METHOD, STREAM PROCESSING APPARATUS, AND STREAM PROCESSING METHOD

(71) Applicant: Panasonic Corporation, Osaka (JP)

(72) Inventors: Kotaro ESAKI, Osaka (JP); Kohei OKADA, Osaka (JP)

(73) Assignee: Panasonic Corporation, Osaka (JP)

(21) Appl. No.: 13/961,064

(22) Filed: Aug. 7, 2013

Related U.S. Application Data
(63) Continuation of application No. PCT/JP2012/000967, filed on Feb. 14, 2012.

(30) Foreign Application Priority Data
Feb. 16, 2011 (JP) 2011-031327

(51) Int. Cl. H04N 7/26

(52) U.S. Cl. CPC H04N 19/00951
USPC 375/240.23

(57) ABSTRACT

A stream generation apparatus includes: a first processing unit which performs, on headers and quantized data, first processing including at least variable-length coding on the headers; a first transfer control unit which transfers the headers on which the first processing has been performed to a first storage area and the quantized data on which the first processing has been performed to a second storage area; a second transfer control unit which obtains headers and quantized data items for a predetermined unit from the first storage area and the second storage area, respectively; and a second processing unit which performs, on the headers and quantized data items for the predetermined unit, second processing including at least compression coding on the quantized data items for the predetermined unit. The second processing unit generates a stream including the compression coded headers followed by the compression coded quantized data.

### CROSS REFERENCE TO RELATED APPLICATION(S)

This is a continuation application of PCT International Application No. PCT/JP2012/000967 filed on Feb. 14, 2012, designating the United States of America, which is based on and claims priority of Japanese Patent Application No. 2011-031327 filed on Feb. 16, 2011. The entire disclosures of the above-identified applications, including the specifications, drawings and claims are incorporated herein by reference in their entirety.

### FIELD

One or more exemplary embodiments or features disclosed herein relate to a stream generation apparatus and a stream generation method which generate a stream by compression coding image data, and to a stream processing apparatus and a stream processing method which decode the stream generated by compression coding.

### BACKGROUND

The recent mainstream for coding schemes of moving pictures is image coding schemes which comply with the H.264/AVC standard (hereinafter referred to as H.264 coding scheme).

Furthermore, the image coding techniques are applied not only to recording of moving pictures onto recording media such as hard disks, DVDs, and BDs, but also to the field of communication. In particular, image coding techniques have recently been gaining attention as compression techniques used for distributing moving pictures on the Internet for which broadband connections are becoming common.

Hence, for example, the H.264 coding scheme also has profiles prepared which are particularly suited for the communication field, including techniques for compensating for missing data, if any. One example of the techniques is data partitioning.

In data partitioning, image coding information is divided into partitions. The partitions are classified into important information and unimportant information. The partitions where important information is stored are made to prevent the information from going missing.

There are disclosed techniques for such data partitioning. For example, Patent Literature 1 discloses a technique relative to a variable length coding system which executes data partitioning with a relatively small amount of hardware.

### CITATION LIST

### Patent Literature

### [PTL 1]

Japanese Unexamined Patent Application Publication No. 11-41108

### SUMMARY

### Technical Problem

The H.264 coding scheme is capable of significantly increasing the coding efficiency by using arithmetic coding that is not used in conventional standards such as MPEG-2.

Furthermore, for the H.264 coding scheme which uses arithmetic coding, vast amounts of computation are necessary in coding moving pictures. Hence, dedicated hardware is necessary in the case where moving pictures need to be coded in real time.

Here, a description is given of a conventional stream generation apparatus which generates a stream of image data (hereinafter, simply referred to as “stream”) obtained by image coding processing.

In an image coding apparatus which performs intra prediction, inter prediction, frequency transform, and quantization on image data, for example, the stream generation apparatus is provided at a stage later than quantization, and generates a stream by coding input data.

The conventional stream generation apparatus generates a stream by compressing quantized data and headers through variable-length coding and arithmetic coding, and outputs the generated stream.

Here, in particular, in variable coding represented by arithmetic coding or the like, the processing amount (the computation amount) necessary for, for example, bitwise data output varies depending on the coding state. Hence, when quantized data and headers are processed, for example, on a per-block basis, such as a macroblock, it is difficult to complete the processing within a predetermined period of time.

In view of this, for example, there is a method in which intermediate data, on which processing up to arithmetic coding has been performed in the preceding unit, is temporarily saved in a main memory and the intermediate data saved in the main memory is restored when arithmetic coding is performed in a subsequent unit. Here, arithmetic coding is performed per unit larger than a block such as the macroblock, that is, for example, on a per-slice or on a per-picture basis.

When the intermediate data generated in the preceding unit is output from the stream generation apparatus and is temporarily saved in the main memory, the intermediate data is successively stored in one area. The subsequent unit in the stream generation apparatus sequentially reads the intermediate data in the storage order, and performs arithmetic coding on the intermediate data in the same order on a per-picture basis, for example.

As a result, in the subsequent unit, for example, a stream with a data array as shown in FIG. 19 is generated and output. Here, a header 1 is a group of pictures (GOP) header, for example. A header 2 is a picture header, for example. A header 3 is a macroblock header, for example.

However, for example, the macroblock header is stored at the beginning of quantized data in each macroblock. More specifically, the data partitioning is not performed in a conventional stream generation apparatus which generates a stream by processing involving arithmetic coding.

It is assumed here that the conventional stream generation apparatus, which generates a stream by processing involving arithmetic coding, performs the data partitioning.

In this case, in a stream, for example, it is necessary that coding information (macroblock headers) required in respective macroblocks is concentrated at one portion.

However, to do so, arithmetic coding needs to be performed after obtaining coding information for all the macroblocks included in a unit of arithmetic coding, such as a picture. Hence, it is necessary to perform processing up to and including arithmetic coding on the unit twice, or to prepare a separate determination circuit and perform arithmetic coding while determining the details of the coding information.

More specifically, such processing involves overhead problems such as data transfer bandwidth, processing cycle, and chip cost for the determination circuit.

In fact, also in the H.264 coding scheme, arithmetic coding is not applicable to profiles to which data partitioning is applicable.

In view of the conventional problems, one non-limiting and exemplary embodiment provides a stream generation apparatus and a stream processing apparatus. The stream generation apparatus is capable of generating a stream having both high error tolerance and high compression rate while reducing overhead such as transfer bandwidth or circuit scale. The stream processing apparatus performs decoding on the stream.

### Solution to Problem

In order to solve the conventional problems, the stream generation apparatus according to one aspect of the present invention is a stream generation apparatus which (i) receives a quantized data item which is a quantized image data item and a header corresponding to the quantized data item and (ii) generates a stream by performing variable-length coding and compression coding in this order on the received header and the received quantized data item. The stream generation apparatus includes: a first processing unit which performs first processing on the received header and the received quantized data item, the first processing including at least the variable-length coding on the header; a first transfer control unit which transfers the header on which the first processing has been performed to a first storage area in a storage unit connected to the stream generation apparatus, and to transfer the quantized data item on which the first processing has been performed to a second storage area in the storage unit; a second transfer control unit which (i) obtains, from the first storage area, a plurality of the headers which are for a predetermined unit and on which the first processing has been performed, and (ii) obtains, from the second storage area, a plurality of the quantized data items which are for the predetermined unit and on which the first processing has been performed; and a second processing unit which performs second processing on the obtained headers and the obtained quantized data items which are for the predetermined unit and on which the first processing has been performed, the second processing including at least the compression coding on the quantized data items which are for the predetermined unit and on which the first processing has been performed. The second processing unit generates a stream including first coded data followed by second coded data, the first coded data being the headers which are for the predetermined unit and which are obtained by the first processing and the second processing, the second coded data being the quantized data items which are for the predetermined unit and which are obtained by the first processing and the second processing.

The stream processing apparatus according to one aspect of the present invention is a stream processing apparatus which decodes a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit. The stream processing apparatus includes: a first decoding processing unit which performs first decoding processing on the stream, the first decoding processing including at least decompression decoding on the second coded data; a first transfer control unit which (i) transfers first data which is the first coded data on which the first decoding processing has been performed, to a first storage area in a storage unit connected to the stream processing apparatus, and (ii) transfers second data which is the second coded data on which the first decoding processing has been performed, to a second storage area in the storage unit; a second transfer control unit which (i) obtains the first data from the first storage area, and obtain the second data from the second storage area, and (ii) outputs each of the headers on which the first decoding processing has been performed and the quantized data item which corresponds to the header and on which the first decoding processing has been performed, the header and the quantized data item being respectively included in the first data and the second data; and a second decoding processing unit configured to perform second decoding processing on the header and the quantized data item on which the first decoding processing has been performed, the header and the quantized data item being output from the second transfer control unit, the second decoding processing including at least variable length decoding on the header. The second decoding processing unit successively outputs the header and the quantized data item corresponding to the header which are obtained by the first decoding processing and the second decoding processing, the header and the quantized data item being in a state before the variable-length coding and the compression coding are performed.

Furthermore, the stream processing apparatus according to another aspect of the present invention is a stream processing apparatus which decodes a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit, the stream including an initial header including positional information indicating a position of beginning of the second coded data in the stream. The stream processing apparatus includes: a stream control unit which obtains the stream, and outputs the first coded data and the second coded data in parallel, based on the positional information read from the initial header in the stream; a first stream processing unit which obtains the header in a state before the variable-length coding and the compression coding are performed, by performing decompression decoding and variable-length decoding on the first coded data output from the stream control unit; a second stream processing unit which obtains the quantized data item in a state before the variable-length coding and the compression coding are performed, by performing the decompression decoding and the variable-length decoding on the second coded data output from the stream control unit; and an output unit which successively outputs the header obtained by the first stream processing unit and the quantized data item corresponding to the header and obtained by the second stream processing unit.

### Advantageous Effects

According to one aspect of the present invention, it is possible to provide a stream generation apparatus and a stream generation method which generate a stream having both high error tolerance and high compression rate while reducing overhead such as transfer bandwidth and implementation circuits. Furthermore, according to one aspect of the present invention, it is possible to provide a stream processing apparatus and a stream processing method which decode the stream.

For example, one aspect of the present invention provides a stream generation apparatus and a stream generation method which allow generation of a stream to which data partitioning and arithmetic coding have been applied. Furthermore, for example, one aspect of the present invention provides a stream processing apparatus and a stream processing method which decode the stream to which data partitioning and arithmetic coding have been applied.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a block diagram schematically showing a configuration of an image coding apparatus according to Embodiment 1.

FIG. 2 is a block diagram schematically showing a configuration of an image coding unit according to Embodiment 1.

FIG. 3 is a block diagram schematically showing a configuration of a stream generation apparatus according to Embodiment 1.

FIG. 4 is a diagram showing an example of a data structure of a stream generated by the stream generation apparatus according to Embodiment 1.

FIG. 5 is a diagram showing detailed configurations of a first transfer control unit and a second transfer control unit in the stream generation apparatus shown in FIG. 3.

FIG. 6 is a block diagram schematically showing a configuration of a header and data separation circuit in the first transfer control unit shown in FIG. 5.

FIG. 7 is a block diagram schematically showing a configuration of a transfer circuit in the header and data separation circuit shown in FIG. 6.

FIG. 8 shows an example of mapping of a main memory according to Embodiment 1.

FIG. 9 is a block diagram schematically showing a configuration of a header and data connection circuit in the second transfer control unit shown in FIG. 5.

FIG. 10 is a block diagram schematically showing a configuration of a transfer circuit in the header and data connection circuit shown in FIG. 9.

FIG. 11 is a flowchart of an example of processing performed by the image coding unit according to Embodiment 1.

FIG. 12A is a flowchart of an example of processing in coding_1 shown in FIG. 11.

FIG. 12B is a flowchart of an example of processing in coding_2 shown in FIG. 11.

FIG. 13 is a block diagram schematically showing a configuration of a stream generation apparatus according to Embodiment 2.

FIG. 14A is a flowchart of an example of processing in coding_1 according to Embodiment 2.

FIG. 14B is a flowchart of an example of processing in coding_2 according to Embodiment 2.

FIG. 15 is a block diagram schematically showing a configuration of a case where the image coding apparatus according to Embodiment 1 includes a first storage area and a second storage area in physically different memories.

FIG. 16 is a block diagram schematically showing a configuration of a case where the image coding unit according to Embodiment 1 is connected to a first main memory and a second main memory.

FIG. 17 shows an example of mapping of the first main memory and mapping of the second main memory shown in FIG. 16.

FIG. 18 is a diagram showing an example of a configuration of an AV system which includes the stream generation apparatus according to Embodiment 1 or Embodiment 2.

FIG. 19 is a diagram showing an example of a data structure of a conventional stream.

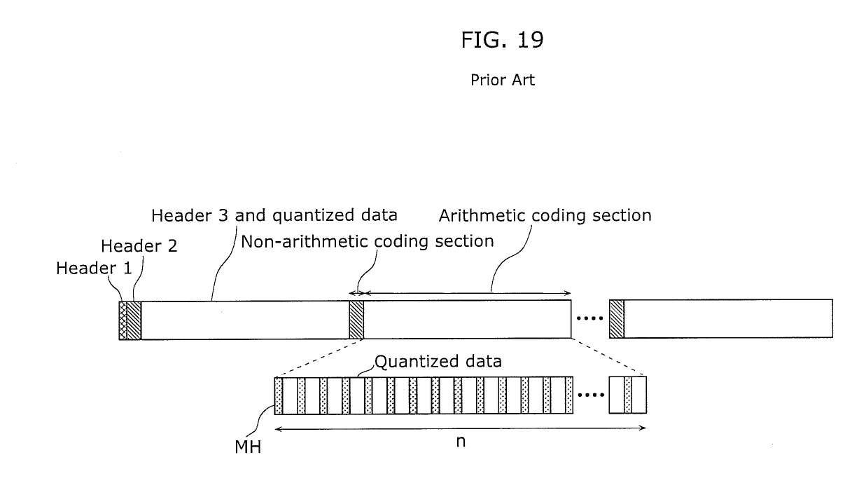

FIG. 20 is a block diagram schematically showing a configuration of an image decoding apparatus according to Embodiment 3.

FIG. 21 is a block diagram schematically showing a configuration of an image decoding unit according to Embodiment 3.

FIG. 22 is a block diagram schematically showing a configuration of a stream processing apparatus according to Embodiment 3.

FIG. 23 is a diagram showing an example of a data structure of a stream input to the stream processing apparatus according to Embodiment 3.

FIG. 24 is a diagram showing a detailed configuration of a first transfer control unit and a second transfer control unit in the stream processing apparatus shown in FIG. 22.

FIG. 25 is a block diagram schematically showing a configuration of a header and data matching circuit in the second transfer control unit shown in FIG. 24.

FIG. 26 is a block diagram schematically showing a configuration of a transfer circuit in the header and data matching circuit shown in FIG. 25.

FIG. 27 is a flowchart of an example of processing performed by the stream processing apparatus according to Embodiment 3.

FIG. 28A is a flowchart of an example of processing in decoding_1 shown in FIG. 27.

FIG. 28B is a flowchart of an example of processing in decoding_2 shown in FIG. 27.

FIG. 29A is a flowchart of another example of processing in decoding_1 shown in FIG. 27.

FIG. 29B is a flowchart of another example of processing in decoding_2 shown in FIG. 27.

FIG. 30 is a block diagram schematically showing a configuration of a stream processing apparatus according to Embodiment 4.

FIG. 31 is a block diagram schematically showing another example of a configuration of the stream processing apparatus according to Embodiment 4.

### DESCRIPTION OF EMBODIMENTS

In the process of generation of a stream, the stream generation apparatus according to one aspect of the present invention temporarily stores, in different storage areas, headers on which the first processing has been performed and quantized data on which the first processing has been performed. Hence, the second transfer control unit is capable of obtaining only quantized data items for a predetermined unit such as a picture, for example. The second processing unit is capable of performing arithmetic coding, which is an example of compression coding, for example, on the quantized data items for the predetermined unit.

As a result, it is possible to generate a stream including: first coded data that is a set of coding information items necessary for decoding; and second coded data that is a set of substantial data items of an image corresponding to the coding information.

Specifically, the stream generation apparatus according to the aspect achieves generation of a stream having both high error tolerance and high compression rate.

Furthermore, in the stream generation apparatus according to one aspect of the present invention, it may be that the first processing unit generates a variable-length coded header which is the header on which the variable-length coding has been performed and a variable-length coded quantized data item which is the quantized data item on which the variable-length coding has been performed, by performing the first processing which is the variable-length coding on the received header and the received quantized data item, the first transfer control unit transfers the variable-length coded header to the first storage area, and transfers the variable-length coded quantized data item to the second storage area, the second transfer control unit obtains the variable-length coded headers for the predetermined unit from the first storage area, and obtains the variable-length coded quantized data items for the predetermined unit from the second storage area, and the second processing unit generates the stream using the first coded data and the second coded data which are obtained by performing the second processing which is the compression coding on the obtained variable-length coded headers for the predetermined unit and the obtained variable-length coded quantized data items for the predetermined unit.

With the configuration, the first processing unit performs variable-length coding on headers and quantized data. The second processing unit performs compression coding on the variable-length coded headers and quantized data.

More specifically, the first transfer control unit transfers the variable-length coded headers and quantized data to different storage areas. Furthermore, the second transfer control unit is capable of separately obtaining the variable-length coded headers for a predetermined unit, such as a picture, and the variable-length coded quantized data items for the predetermined unit. Accordingly, for example, the second processing unit is capable of performing compression coding on the quantized data items for the predetermined unit after performing compression coding on the headers for the predetermined unit.

More specifically, the above configuration also allows generation of a stream which has higher error tolerance achieved by coding information being concentrated in a predetermined range and which is coded by a high-compression method such as arithmetic coding.

Furthermore, in the stream generation apparatus according to one aspect of the present invention, it may be that the first processing unit performs the first processing including (i) the variable-length coding and the compression coding on the received header and (ii) inputting the received quantized data item to the first transfer control unit, the first transfer control unit transfers the header on which the variable-length coding and the compression coding have been performed to the first storage area, and to transfer the input quantized data item to the second storage area, the second transfer control unit obtains, from the first storage area, the headers which are for the predetermined unit and on which the variable-length coding and the compression coding have been performed, and to obtain the quantized data items for the predetermined unit from the second storage area, and the second processing unit generates the stream using the first coded data and the second coded data which are obtained by the second processing including (i) receiving the obtained headers for the predetermined unit from the second transfer control unit and (ii) the variable-length coding and the compression coding on the obtained quantized data items for the predetermined unit.

With the configuration, the first processing unit performs variable-length coding and compression coding on headers, and the second processing unit performs variable-length coding and compression coding on quantized data.

More specifically, the first transfer control unit transfers quantized data and the compression-coded headers to different storage areas. Furthermore, the second transfer control unit is capable of separately obtaining the headers, for a predetermined unit such as a picture, on which processing up to and including compression coding has been performed, and quantized data items, for the predetermined unit, on which variable-length coding and compression coding have not been performed.

Accordingly, the second processing unit performs variable-length coding and compression coding on the quantized data items for a predetermined unit, and generates a stream including first coded data followed by second coded data. The first coded data is headers, for the predetermined unit, on which processing up to and including compression coding has been performed. The second coded data is quantized data items, for the predetermined unit, on which processing up to and including compression coding has been performed.

More specifically, the above configuration also allows generation of a stream which has higher error tolerance achieved by coding information being concentrated in a predetermined range and which is coded by a high-compression method such as arithmetic coding.

Furthermore, in the stream generation apparatus according to one aspect of the present invention, it may be that when transferring the header on which the first processing has been performed to the first storage area, the first transfer control unit transfers the header to allow at least part of the header and part of an other header to be successively stored in one word in the first storage area, and when transferring the quantized data item on which the first processing has been performed to the second storage area, the first transfer control unit transfers the quantized data item to allow at least part of the quantized data item and part of an other quantized data item to be successively stored in one word in the second storage area.

With the configuration, when headers are temporarily stored in the first storage area, the headers are efficiently stored without wasting the storage capacity. Furthermore, in the similar manner, the quantized data is also efficiently stored in the second storage area without wasting the storage capacity.

Furthermore, in the stream generation apparatus according to one aspect of the present invention, it may be that the first transfer control unit includes first address information and second address information which are referred to when transferring the header and the quantized data item, the first address information indicating an address in the first storage area at which the header, on which the first processing has been performed and which is transferred by the first transfer control unit, is stored, the second address information indicating an address in the second storage area at which the quantized data item, on which the first processing has been performed and which is transferred by the first transfer control unit, is stored.

With the configuration, for example, storage of the headers into the first storage area and storage of the quantized data into the second storage area are appropriately executed under management based on the first address information and the second address information, respectively.

Furthermore, in the stream generation apparatus according to one aspect of the present invention, it may be that the first transfer control unit (i) transfers the header on which the first processing has been performed to the first storage area in a first memory in the storage unit, to store the header in the first storage area, and (ii) transfers the quantized data item on which the first processing has been performed to the second storage area in a second memory in the storage unit, to store the quantized data item in the second storage area, the second memory being physically different from the first memory.

Furthermore, in the stream generation apparatus according to one aspect of the present invention, it may be that the first transfer control unit (i) transfers the header on which the first processing has been performed to the first storage area in a memory in the storage unit, to store the header in the first storage area, and (ii) transfers the quantized data item on which the first processing has been performed to the second storage area in the memory, to store the quantized data item in the second storage area.

More specifically, the first storage area for temporarily storing the headers, and the second storage area for temporarily storing the quantized data may exist in two physically different memories, or may exist in the physically same memory.

Furthermore, in the stream generation apparatus according to one aspect of the present invention, it may be that the second transfer control unit obtains, from the first storage area, the headers which are for one picture and on which the first processing has been performed, and obtains, from the second storage area, the quantized data items which are for the one picture and on which the first processing has been performed, the one picture being the predetermined unit, and the second processing unit performs the second processing on the obtained headers for the one picture and the obtained quantized data items for the one picture, and generates a stream including the first coded data for the one picture followed by the second coded data for the one picture.

Furthermore, one or more exemplary embodiments or features disclosed herein may also be implemented as an image coding apparatus which includes the stream generation apparatus according to any one of the above aspects.

Furthermore, one or more exemplary embodiments or features disclosed herein may also be implemented as a stream generation method which includes characteristics processing executed by the stream generation apparatus according to any one of the above aspects. Furthermore, one or more exemplary embodiments or features disclosed herein may also be implemented as a program causing a computer to execute each processing included in the stream generation method, and as a recording medium on which the program is recorded. The program may be distributed via a transmission medium such as the Internet or a recording medium such as a DVD.

One or more exemplary embodiments or features disclosed herein may also be implemented as an integrated circuit which includes part or all of the configuration of the stream generation apparatus according to any one of the aspects.

Furthermore, the stream processing apparatus according to one of the aspects of the present invention is capable of efficiently decoding a stream having both high error tolerance and high compression rate.

More specifically, first data and second data are temporarily stored in different storage areas. The first data and the second data are results of processing performed in the preceding stage on the first coded data (headers: coding information important for decoding) and the second coded data (quantized data: substantial data of an image), respectively. The first coded data and the second coded data are included in a stream obtained by variable-length coding and compression coding.

For example, the first data and the second data can be temporarily stored in different storage areas, per predetermined unit suitable for decoding.

Furthermore, the subsequent processing is appropriately performed on the first data and the second data read from the storage areas.

As a result, a pair of one of headers for the predetermined unit and quantized data corresponding to the header, which are in the state before variable-length coding and compression coding are performed, is sequentially output.

Furthermore, in the stream processing apparatus according to one aspect of the present invention, it may be that the first decoding processing unit generates the first data and the second data by performing the first decoding processing which is the decompression decoding on the first coded data and the second coded data, and the second decoding processing unit generates the header and the quantized data item in a state before the variable-length coding and the compression coding are performed, by performing the second decoding processing which is the variable-length decoding on the header and the quantized data item on which the decompression decoding has been performed.

With the configuration, the first decoding processing unit performs decompression decoding on headers and quantized data, and the second processing unit performs variable-length decoding on the decompression coded headers and quantized data, in other words, such a configuration also allows efficient decoding of a stream obtained by variable-length coding and compression coding.

Furthermore, in the stream processing apparatus according to one aspect of the present invention, it may be that the first decoding processing unit performs the first decoding processing including (i) the decompression decoding and the variable-length decoding on the second coded data and (ii) inputting the first coded data to the first transfer control unit, the first transfer control unit (i) transfers, to the first storage area, the first coded data input from the first decoding processing unit, and (ii) transfers the second coded data on which the decompression decoding and the variable-length decoding have been performed to the second storage area, the first coded data being the first data, the second coded data being the second data, the second transfer control unit outputs each of the headers on which the decompression decoding and the variable-length decoding have been performed and the quantized data item which corresponds to the header and on which the compression decoding and the variable-length decoding have not been performed, the header and the quantized data item being respectively included in the obtained first data and the obtained second data, and the second decoding processing unit generates the header and the quantized data item which are in a state before the variable-length coding and the compression coding are performed, by performing the second decoding processing including (i) receiving the header on which the decompression decoding and the variable-length decoding have been performed from the second transfer control unit and (ii) performing the decompression decoding and the variable-length decoding on the quantized data item output from the second transfer control unit.

With the configuration, the first decoding processing unit performs decompression decoding and variable-length decoding on headers, and the second processing unit performs decompression decoding and variable-length decoding on quantized data. In other words, such a configuration also allows efficient decoding of a stream obtained by variable-length coding and compression coding.

Furthermore, in the stream processing apparatus according to one aspect of the present invention, it may be that when transferring the first data to the first storage area, the first transfer control unit transfers the first data to allow at least part of one header and part of an other header which are included in the first data to be successively stored in one word in the first storage area, and when transferring the second data to the second storage area, the first transfer control unit transfers the second data to allow at least part of one quantized data item and part of an other quantized data item which are included in the second data to be successively stored in one word in the second storage area.

With the configuration, when headers are temporarily stored in the first storage area, the headers are efficiently stored without wasting the storage capacity, Likewise, the quantized data is also efficiently stored in the second storage area without wasting the storage capacity.

Furthermore, in the stream processing apparatus according to one aspect of the present invention, it may be that the first transfer control unit includes first address information and second address information which are referred to when transferring the first data and the second data, the first address information indicating an address in the first storage area at which the first data transferred from the first transfer control unit is stored, the second address information indicating an address in the second storage area at which the second data transferred from the first transfer control unit is stored.

With the configuration, for example, storage of the first data into the first storage area and storage of the second data into the second storage area are appropriately executed under management based on the first address information and the second address information, respectively.

Furthermore, in the stream processing apparatus according to one aspect of the present invention, it may be that the first transfer control unit (i) transfers the first data to the first storage area in a first memory in the storage unit, to store the first data in the first storage area, and (ii) transfers the second data to the second storage area in a second memory in the storage unit, to store the second data in the second storage area, the second memory being physically different from the first memory.

Furthermore, in the stream processing apparatus according to one aspect of the present invention, it may be that the first transfer control unit (i) transfers the first data to the first storage area in a memory in the storage unit, to store the first data in the first storage area, and (ii) transfers the second data to the second storage area in the memory, to store the second data in the second storage area.

More specifically, the first storage area for temporarily storing the headers, and the second storage area for temporarily storing the quantized data may exist in two physically different memories, or may exist in the physically same memory.

Furthermore, in the stream processing apparatus according to one aspect of the present invention, it may be that the first decoding processing unit performs the first decoding processing on the first coded data which is the headers for one picture and the second coded data which is the quantized data items for the one picture, the one picture being the predetermined unit, and the first transfer control unit (i) transfers, to the first storage area, the first data including the headers which are for the one picture and on which the first decoding processing has been performed and (ii) transfers, to the second storage area, the second data including the quantized data items which are for the one picture and on which the first decoding processing has been performed.

Furthermore, the stream processing apparatus according to another aspect of the present invention is capable of instantly determining the position of the boundary between the first coded data and the second coded data by referring to the positional information included in the initial header in a stream. Hence, it is possible to input the first coded data and the second coded data in parallel, to the respective processing units (the first stream processing unit and the second stream processing unit).

As a result, for example, decoding of headers for one picture and decoding of quantized data items for the one picture are performed in parallel. In other words, such a configuration also allows efficient decoding of a stream obtained by variable-length coding and compression coding.

Furthermore, one or more exemplary embodiments or features disclosed herein may also be implemented as an image decoding apparatus which includes the stream processing apparatus according to any one of the above aspects.

Furthermore, one or more exemplary embodiments or features disclosed herein may also be implemented as a stream processing method which includes characteristics processing executed by the stream generation apparatus according to any one of the above aspects. Furthermore, one or more exemplary embodiments or features disclosed herein may also be implemented as a program causing a computer to execute processing included in the stream processing method, and as a recording medium on which the program is recorded. The program may be distributed via a transmission medium such as the Internet or a recording medium such as a DVD.

Hereinafter, a description is given of embodiments of the present invention, referring to the drawings. Note that, the diagrams are schematic diagrams, and the illustration is not always strictly accurate.

Each embodiment described below shows a preferred specific example of the present invention. The numerical values, shapes, structural elements, the arrangement and connection of the structural elements etc. shown in the following embodiments are mere examples, and therefore do not limit the present invention. The present invention is limited by the scope of the appended Claims. Therefore, among the structural elements in the following embodiments, structural elements not recited in any one of independent claims are not necessarily required to achieve embodiments of the present invention; but are described as the elements for a preferred embodiment.

Furthermore, in the following description, same reference numbers are assigned to the same structural elements. Their names and functions are also the same. Hence, detailed descriptions thereof may not be repeated.

### Embodiment 1

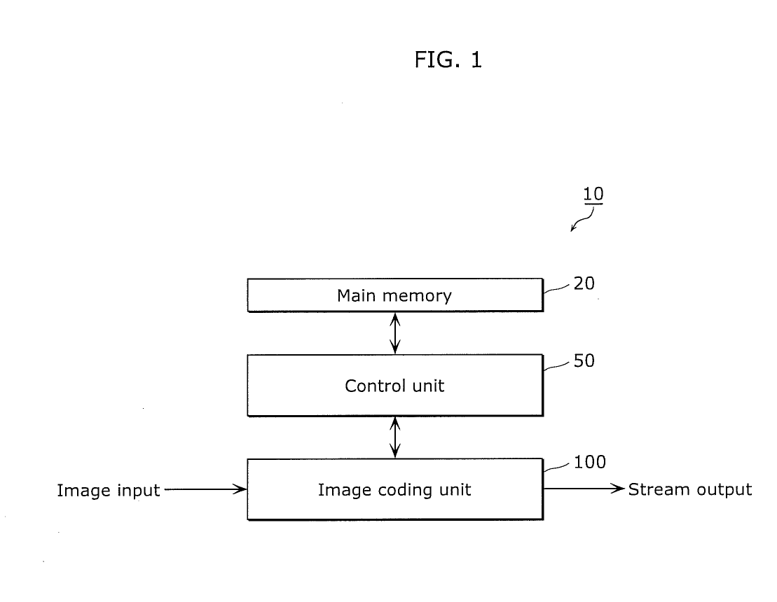

FIG. 1 is a block diagram schematically showing a configuration of an image coding apparatus 10 according to Embodiment 1.

As shown in FIG. 1, the image coding apparatus 10 includes an image coding unit 100, a control unit 50 and a main memory 20.

The main memory 20 is a memory for storing data (for example, dynamic random access memory (DRAM)).

The control unit 50 includes a processor, such as a central processing unit (CPU) (not shown), and a memory control circuit (not shown).

In the image coding apparatus 10, the image coding unit 100 generates, relative to an input image, compressed data generated while saving and restoring intermediate data via the control unit 50, using the main memory 20 provided outside the image coding unit 100, and outputs the generated data as a stream.

The control unit 50 controls not only transfer of data between the image coding unit 100 and the main memory 20, but also controls the image coding unit 100.

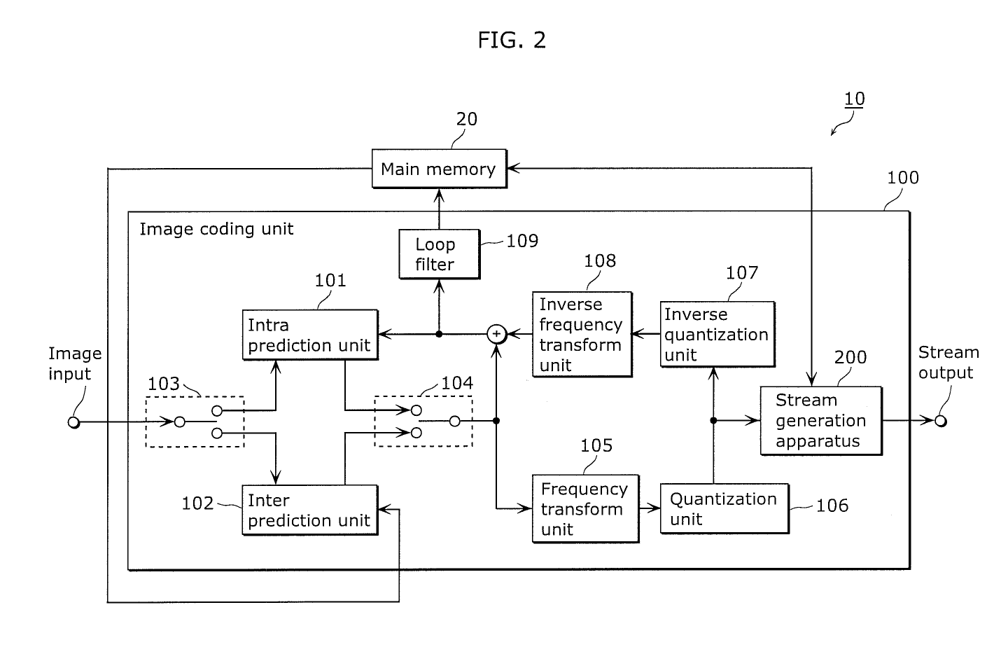

FIG. 2 is a block diagram schematically showing a configuration of the image coding unit 100 according to Embodiment 1.

Referring to FIG. 2, a description is given of basic processing performed by the image coding unit 100. The control unit 50 shown in FIG. 1 is not shown in FIG. 2.

An image input to the image coding unit 100 is input to an intra prediction unit 101 and an inter prediction unit 102, via a switch 103. The intra prediction unit 101 removes redundant information by prediction using spatial correlation within a picture. The inter prediction unit 102 removes redundant information by prediction using temporal correlation between pictures.

A switch 104 selects one of the intra prediction unit 101 and the inter prediction unit 102 according to the type of a picture to be coded, or which one of the intra prediction and the inter prediction is suitable for coding the picture. Accordingly, difference data which is data of a difference image between the input image and a prediction image is input to a frequency transform unit 105.

The difference data input to the frequency transform unit 105 is transformed into two-dimensional frequency component information by, for example, discrete cosine transform (DCT). The DCT coefficient data obtained by the transform is compressed by a quantization unit 106 removing high-frequency components that have less influences on human vision.

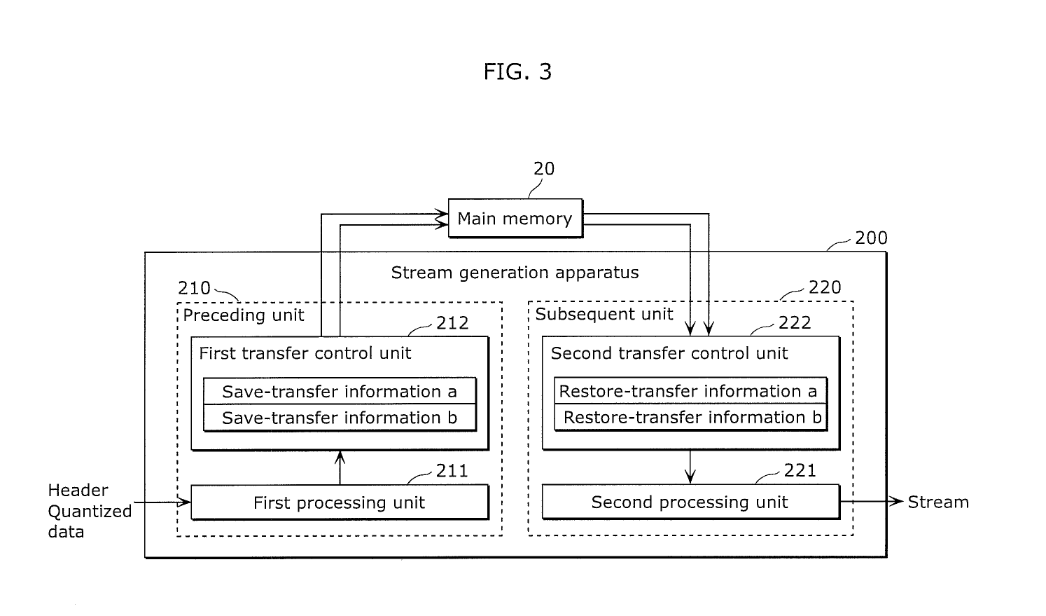

The data which is provided by the quantization unit 106 and in which low-frequency components are relatively concentrated (hereinafter, referred to as quantized data) is further compressed in a stream generation apparatus 200 by variable-length coding, arithmetic coding, and others in the zigzag order in which the data is scanned. Initial information (hereinafter, referred to as “header”) indicating coding information, such as a coding type, is added to the compressed data, and the data is output as a stream. A detailed description will be given of the stream generation apparatus 200, referring to FIG. 3 and others.

Furthermore, the quantized data is input to an inverse quantization unit 107 to be restored to information approximating to the state before the quantization. Subsequently, an inverse frequency transform unit 108 restores the data to the original difference image data or data approximating the original difference image data. The restored data and prediction image data corresponding to the restored data are combined to generate a reconstructed image. The generated reconstructed image is saved in the main memory 20 or the reconstructed image is saved in the main memory 20 after being deblocking filtered by a loop filter 109. The saved image is read from the main memory 20 when inter prediction is performed.

The frequency transform unit 105 and the inverse frequency transform unit 108 may use a method other than DCT, as a frequency transform method. Furthermore, the scanning order in the stream generation apparatus 200 may be other than zigzag order. Furthermore, the method of compression coding in the stream generation apparatus 200 may be other than variable-length coding and arithmetic coding.

FIG. 3 is a block diagram schematically showing a configuration of the stream generation apparatus 200 according to Embodiment 1.

The stream generation apparatus 200 includes a preceding unit 210 and a subsequent unit 220. Each of the preceding unit 210 and the subsequent unit 220 is capable of communicating with the main memory 20 which is an example of a storage unit and which is connected to the stream generation apparatus 200.

The stream generation apparatus 200 compresses quantized data input from the quantization unit 106 and headers indicating coding information necessary for decoding the image, by variable-length coding and arithmetic coding, for example, and generates a stream data.

Here, in particular, in the case where variable coding represented by arithmetic coding and the like is performed, the processing amount (computation amount) necessary for, for example, bitwise data output varies depending on the state, as described above.

In view of the above, in the stream generation apparatus 200 according to Embodiment 1, a method is used in which intermediate data on which processing up to arithmetic coding has been performed is temporarily saved in the main memory 20, and the intermediate data saved in the main memory 20 is restored when arithmetic coding is performed.

The arithmetic coding is performed on a per-slice or on a per-picture basis, which is a unit larger than a macroblock and a block, as described above.

More specifically, the preceding unit 210 includes a first processing unit 211 and a first transfer control unit 212. The first processing unit 211 performs first processing including at least variable-length coding on headers. The first transfer control unit 212 transfers the headers on which the first processing has been performed to a first storage area in the main memory 20, and transfers the quantized data on which the first processing has been performed to a second storage area in the main memory 20.

More specifically, the first processing unit 211 according to Embodiment 1 performs first processing, which is variable-length coding on headers and quantized data, to generate variable-length coded headers and variable-length coded quantized data. In Embodiment 1, binarization is performed as the variable-length coding.

Furthermore, the first transfer control unit 212 according to Embodiment 1 transfers the variable-length coded headers to the first storage area, and the variable-length coded quantized data to the second storage area. More specifically, the first transfer control unit 212 saves, in different storage areas in the main memory 20, the variable-length coded headers and the variable-length coded quantized data each of which is intermediate data.

The first transfer control unit 212 holds at least two types of transfer control information for controlling such save processing, and refers to the transfer control information when performing the save processing (transfer processing).

More specifically, the first transfer control unit 212 holds save-transfer information a corresponding to the first storage area and save-transfer information b corresponding to the second storage area.

The subsequent unit 220 includes a second processing unit 221 and a second transfer control unit 222. The second transfer control unit 222 obtains, from the first storage area, the headers, for a predetermined unit, on which the first processing has been performed, and obtains, from the second storage area, the quantized data items, for the predetermined unit, on which the first processing has been performed.

The second processing unit 221 performs second processing including at least the compression coding on quantized data items for a predetermined unit. The second processing unit 221 further generates a stream including first coded data followed by second coded data which are obtained by the first processing and the second processing.

The first coded data refers to data that is headers which are for a predetermined unit and on which variable-length coding and compression coding have been performed. The second coded data refers to data that is quantized data items which are for the predetermined unit and on which variable-length coding and compression coding have been performed.

More specifically, the second transfer control unit 222 according to Embodiment 1 obtains, from the first storage area, the variable-length coded headers for a predetermined unit, and obtains, from the second storage area, variable-length coded quantized data items for the predetermined unit. In other words, the intermediate data saved in the first storage area and the second storage area are restored by the second transfer control unit 222.

The second transfer control unit 222 holds at least two types of transfer control information for controlling such restore processing, and refers to the transfer control information when performing the restore processing (transfer processing).

More specifically, the second transfer control unit 222 holds restore-transfer information a corresponding to the first storage area and restore-transfer information b corresponding to the second storage area.

The second processing unit 221 according to Embodiment 1 generates a stream using the first coded data and the second coded data obtained by compression coding the obtained variable-length coded headers for the predetermined unit and the obtained variable-length coded quantized data items for the predetermined unit. In Embodiment 1, arithmetic coding is performed as the compression coding.

With such a configuration, the stream generation apparatus 200 achieves generation of a stream to which both data partitioning and arithmetic coding have been applied.

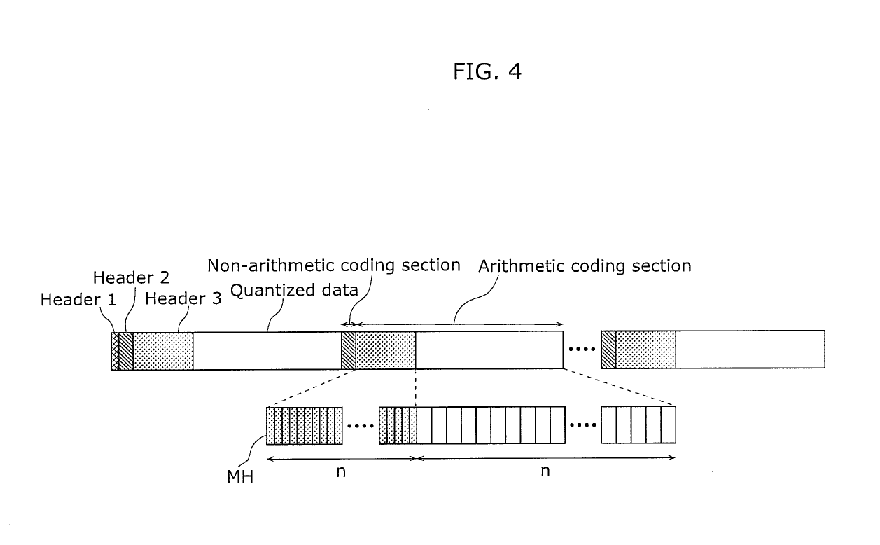

FIG. 4 shows an example of a data structure of a stream generated by the stream generation apparatus 200 according to Embodiment 1.

In performing data partitioning, important information is concentrated at portions with higher error tolerance. Hence, headers, in particular, are often concentrated at a predetermined position. In particular, headers which are assigned on a per-block basis, such as a macroblock, are concentrated at the beginning of a stream, or at the beginning of a portion where data is stored on a per-slice basis or on a per-picture basis. In other words, other data, such as quantized data, is stored at a completely different position.

FIG. 4 shows an example of a structure of data after data partitioning, having such characteristics. A header 1 is, for example, a GOP header, a header 2 is, for example, a picture header, and a header 3 is, for example, a macroblock header (denoted as “MH” in FIG. 4).

More specifically, the stream shown in FIG. 4 consists of data on which arithmetic coding has been performed on a per-picture basis. The stream includes a set of n macroblock headers corresponding to a set of n macroblocks included in one picture, followed by a set of n quantized data items corresponding to the set of macroblock headers. The set of macroblock headers is an example of the first coded data, and the set of the quantized data items are an example of the second coded data.

The correspondence relationship between the headers 1 to 3 and the types of header are not limited to the above relationship. For example, in the above correspondence relationship, the header 2 may be a slice header, or a picture header and a slice header.

Furthermore, for example, it may be that the header 1 is a picture header, the header 2 is a slice header, and the header 3 is a macroblock header.

Furthermore, it is not necessary that three types of headers are included as shown in FIG. 4. For example, it may be that no GOP header is present, and at least the picture headers or the slice headers and the macroblock headers are concentrated in the stream.

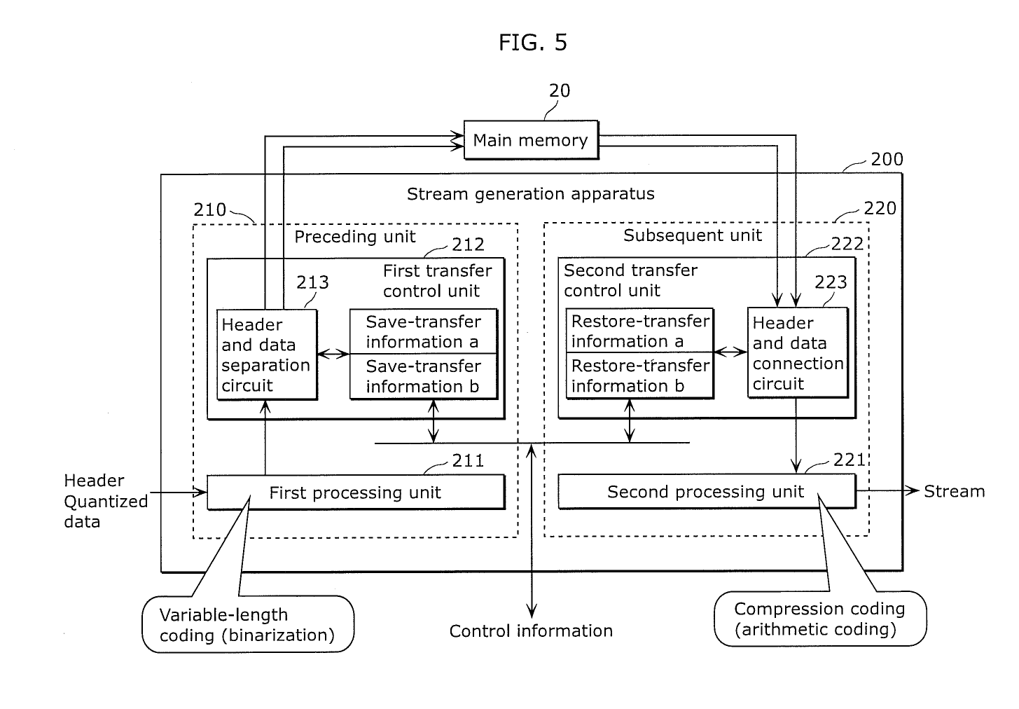

A description is given of a configuration for generating the stream which involves such data partitioning, referring to FIG. 5 to FIG. 10.

FIG. 5 is a diagram showing a detailed configuration of the first transfer control unit 212 and the second transfer control unit 222 in the stream generation apparatus 200 shown in FIG. 3.

The first transfer control unit 212 in the preceding unit 210 has control information for controlling transfer of various data, for example, which are the save-transfer information a and the save-transfer information b, preset by the control unit 50 which controls the operations of the image coding unit 100.

In the first transfer control unit 212, a header and data separation circuit 213 separates the intermediate data input from the first processing unit 211 and transfers the separated data to predetermined areas in the main memory 20, based on the information.

More specifically, the header and data separation circuit 213 obtains the variable-length coded headers and quantized data obtained by binarization performed by the first processing unit 211. The header and data separation circuit 213 transfers the variable-length coded headers that are binary data to the first storage area in the main memory 20 according to the save-transfer information a. The header and data separation circuit 213 also transfers the variable-length coded quantized data that is binary data to the second storage area in the main memory 20 according to the save-transfer information b.

The save-transfer information a is an example of first address information, and for example, includes information indicating an address in the first storage area at which the headers are stored. Furthermore, the save-transfer information b is an example of second address information, and, for example, includes information indicating an address in the second storage area at which the quantized data is stored.

On the other hand, the second transfer control unit 222 in the subsequent unit 220 has control information for controlling transfer of various data, for example, which are the restore-transfer information a and the restore-transfer information b, preset by the control unit 50 which controls the operations of the image coding unit 100.

In the second transfer control unit 222, a header and data connection circuit 223 transfers intermediate data from a predetermined area in the main memory 20 based on the information, connects the intermediate data, and outputs the connected data to the second processing unit 221.

More specifically, the header and data connection circuit 223 obtains, from the first storage area in the main memory 20, the variable-length coded headers for a predetermined unit, such as a picture, according to the restore-transfer information a Furthermore, the header and data connection circuit 223 obtains, from the second storage area in the main memory 20, the variable-length coded quantized data items for the predetermined unit, according to the restore-transfer information b.

The restore-transfer information a includes, for example, information indicating an address in the first storage area at which the headers are stored. The restore-transfer information b includes, for example, information indicating an address in the second storage area at which quantized data is stored.

The header and data connection circuit 223 connects the obtained variable-length coded headers and quantized data items for the predetermined unit for input to the second processing unit 221. The second processing unit 221 generates a stream by compressing, through arithmetic coding, the received variable-length coded headers and quantized data items for the predetermined unit.

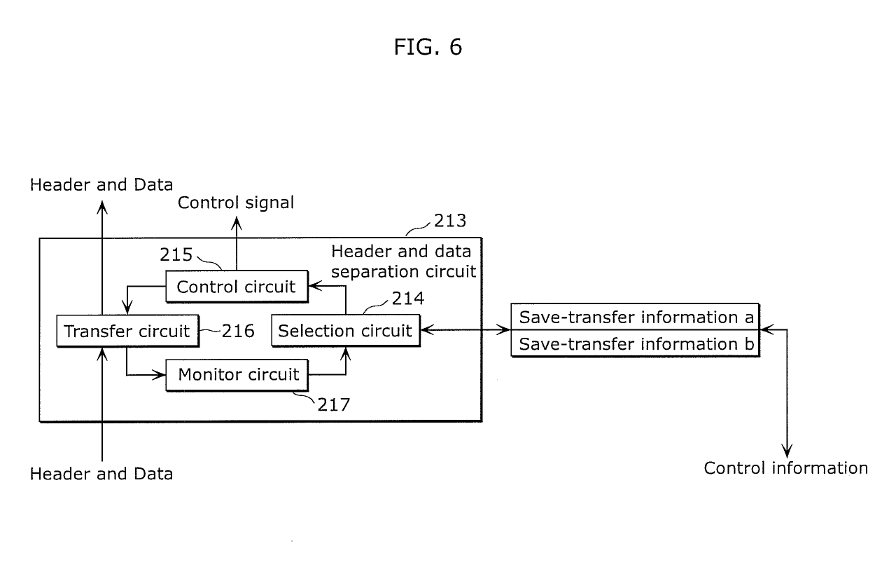

FIG. 6 is a block diagram schematically showing a configuration of the header and data separation circuit 213 in the first transfer control unit 212 shown in FIG. 5.

The header and data separation circuit 213 transfers, to the main memory 20, the intermediate data input from the first processing unit 211, based on the information set to the save-transfer information a and the save-transfer information b.

More specifically, in the case where the intermediate data input from the first processing unit 211 is the variable-length coded headers (hereinafter, may also be simply referred to as “headers”), for example, if the save-transfer information a includes information to be used for transferring the intermediate data to the first storage area (such as an address at which the headers are stored), a selection circuit 214 selects the information, and provides the information to a control circuit 215.

The control circuit 215 outputs an address in the first storage area in the main memory 20 at which the headers are to be stored and a control signal necessary for writing. The control circuit 215 also provides, to a transfer circuit 216, a control signal for synchronization with the headers output by the transfer circuit 216.

The transfer circuit 216 outputs the headers to the main memory 20 based on the control signal input from the control circuit 215. Furthermore, the header information is provided to a monitor circuit 217 via the transfer circuit 216. The monitor circuit 217 applies feedback of the information used for the transfer, as save information, to part of the save-transfer information a.

The save information used for the transfer of the headers which is stored in the save-transfer information a is read by the control unit 50, and used for update or the like of the restore-transfer information a included in the subsequent unit 220.

Subsequently, in the case where the intermediate data input from the first processing unit 211 is variable-length coded quantized data (hereinafter, may also be simply referred to as “quantized data”), for example, if the save-transfer information b includes information to be used for transfer of the quantized data to the second storage area (such as an address at which the quantized data is stored), the selection circuit 214 selects the information and provides the selected information to the control circuit 215.

The control circuit 215 outputs an address in the second storage area in the main memory 20 at which the quantized data is to be stored, and a control signal necessary for writing. The control circuit 215 also provides, to the transfer circuit 216, a control signal for synchronization with the headers output by the transfer circuit 216.

The transfer circuit 216 outputs the quantized data to the main memory 20 based on the control signal input from the control circuit 215. Furthermore, the quantized data information is provided to the monitor circuit 217 via the transfer circuit 216. The monitor circuit 217 applies feedback of the information used for the transfer, as save information, to part of the save-transfer information b.

The save information used for the transfer of the quantized data and stored in the save-transfer information b is read by the control unit 50, and is used for updating or the like of the restore-transfer information b included in the subsequent unit 220.

The headers transferred to the first storage area as intermediate data are not stored in different words in the first storage area, but the headers for a predetermined unit, such as a picture, are stored in the same word in the first storage area, for example.

More specifically, focusing on a given header, the header is transferred to the first storage area to allow at least part of the header and at least part of another header to be successively stored in one word.

For example, it is assumed that one word is 16 bits and a given header is 10 bits. In this case, for example, the whole header and 6 bits from the beginning of a subsequent header are stored in an empty word.

The same also applies to the quantized data. More specifically, quantized data is transferred to the second storage area to allow at least part of the quantized data and at least part of another quantized data item to be successively stored in one word in the second storage area.

By storing intermediate data in each of the first storage area and the second storage area in succession in such a manner, the storage capacities of the first storage area and the second storage area are not wasted. In other words, the first storage area and the second storage area are efficiently used.

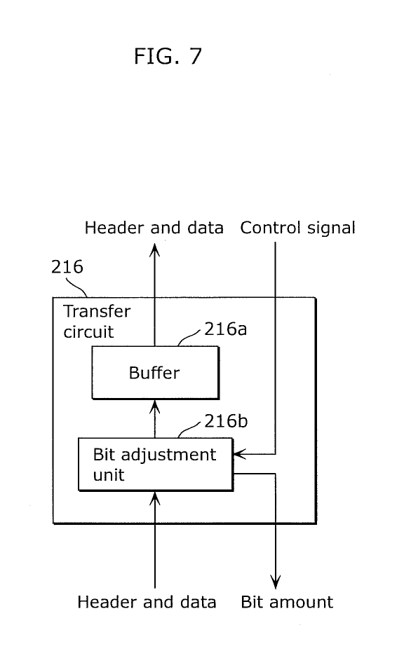

FIG. 7 is a block diagram schematically showing a configuration of the transfer circuit 216 in the header and data separation circuit 213 shown in FIG. 6.

In the transfer circuit 216, a bit adjustment unit 216b divides intermediate data such as the headers or the quantized data input from the first processing unit 211 into the data amount suitable for transfer to the main memory 20, according to a control signal input from the control circuit 215, and provides the divided data to an internal buffer 216a. More specifically, a unit of output, such as bit or byte, is adjusted so that the intermediate data is output in synchronization with the address and the control signal output from the control circuit 215.

Furthermore, the bit adjustment unit 216b detects the end of the header input from the first processing unit 211. The bit adjustment unit 216b performs the following processing, for example, when the detection result shows that the size of the header is larger than the unit of transfer used in transfer to the main memory 20 and part of the header becomes a remaining portion.

The bit adjustment unit 216b temporarily saves the remaining portion in the internal buffer 216a till a subsequent header is input, for example. Alternatively, the bit adjustment unit 216b transfers the data after adding meaningless data to the end of the remaining portion to fit in the unit of transfer in the transfer to the main memory 20.

Here, in any cases, the bit adjustment unit 216b provides, to the monitor circuit 217 for each data transfer, the amount of data transferred to the main memory 20 as bit amount information.

In such a manner, the transfer circuit 216 keeps, for each data transfer, information indicating the state of the header at the time of completion of the transfer.

Accordingly, when a subsequent header is input from the first processing unit 211 and when the remaining portion of a previous header is saved in the internal buffer 216a in the previous transfer, it is possible to restore the saved remaining portion of the header and connect the end of the remaining portion and the beginning of the subsequent header to be transferred.

Furthermore, when meaningless data is added to the end of the remaining portion of the previous header, it is easily determined that the current header to be transferred can be output to the main memory 20 from the beginning of the current header as it is.

Descriptions have been given above of the control performed by the transfer circuit 216 when headers are transferred. The similar control is performed when quantized data is transferred.

Furthermore, the headers and the quantized data, which are intermediate data and are transferred from the transfer circuit 216, are stored in different storage areas in the main memory 20.

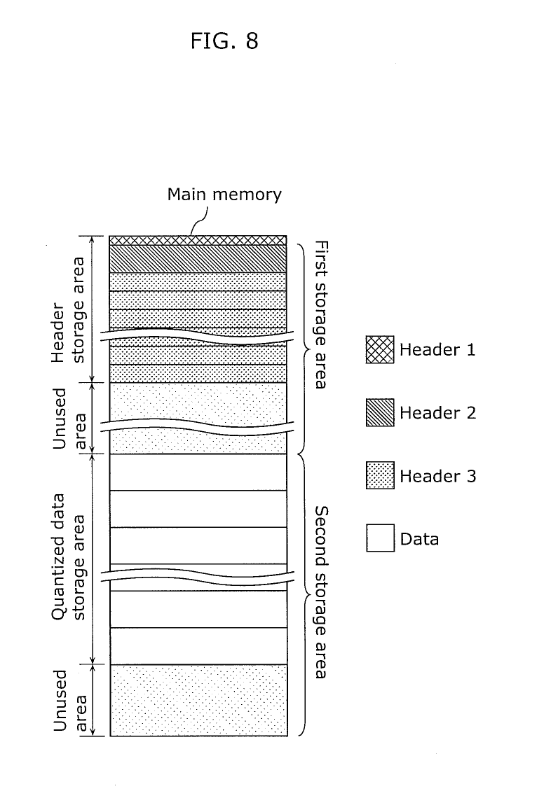

FIG. 8 shows an example of mapping of the main memory 20 according to Embodiment 1.

As described above, intermediate data is output from the first transfer control unit 212 in the stream generation apparatus 200 and is temporarily stored in the main memory 20.

Here, in Embodiment 1, as shown in FIG. 8, the area where intermediate data is written according to the save-transfer information a and the area where intermediate data is written according to the save-transfer information b are different storage areas in the physically same main memory 20.

More specifically, the main memory 20 includes a first storage area where headers are written according to the save-transfer information a and the second storage area where quantized data is written according to the save-transfer information b.

In such a manner, the intermediate data stored in the main memory 20 is obtained by the second transfer control unit 222 in the stream generation apparatus 200. More specifically, the second transfer control unit 222 obtains the intermediate data from the main memory 20 according to the restore-transfer information a and the restore-transfer information b in the above manner.

Here, the area from which the intermediate data is read according to the restore-transfer information a and the area where the intermediate data is stored according to the save-transfer information a are the same, and are in the first storage area.

Furthermore, the area from which the intermediate data is read according to the restore-transfer information b and the area where the intermediate data is stored according to the save-transfer information b are the same, and are in the second storage area.

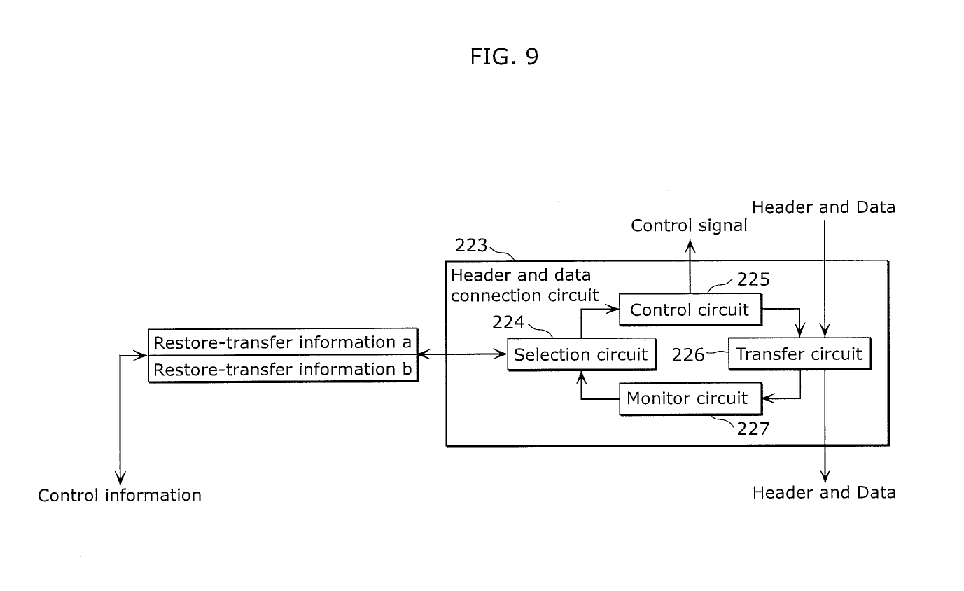

FIG. 9 is a block diagram schematically showing a configuration of the header and data connection circuit 223 in the second transfer control unit 222 shown in FIG. 5.

The header and data connection circuit 223 obtains, from the main memory 20, the intermediate data to be output to the second processing unit 221, based on the information set to the restore-transfer information a or the restore-transfer information b.

More specifically, when the intermediate data to be output to the second processing unit 221 are headers, and if the restore-transfer information a includes the information to be used for transfer from the first storage area (such as the address at which the headers are stored), a selection circuit 224 selects the information and provides the selected information to a control circuit 225.

The control circuit 225 outputs the address in the first storage area in the main memory 20 at which the headers are stored and a control signal necessary for reading. The control circuit 225 also provides, to a transfer circuit 226, a control signal for synchronization with the headers input to the transfer circuit 226.

The transfer circuit 226 obtains the headers from the main memory 20, based on the control signal input from the control circuit 225. Furthermore, the header information is provided to a monitor circuit 227 via the transfer circuit 226, The information used for the transfer is matched, as restore information, to part of the restore-transfer information a.

The restore information which is used for the transfer of the headers and which is stored in the restore-transfer information a is preset by the control unit 50.

Subsequently, when the intermediate data to be output to the second processing unit 221 is quantized data, and if the restore-transfer information b includes information to be used for transfer of the intermediate data from the second storage area, the selection circuit 224 selects the information and provides the selected information to the control circuit 225.

The control circuit 225 outputs the address in the main memory 20 at which the quantized data is stored and a control signal necessary for reading. The control circuit 225 also provides, to the transfer circuit 226, a control signal for synchronization with the quantized data input to the transfer circuit 226.

The transfer circuit 226 obtains the quantized data from the main memory 20, based on the control signal input from the control circuit 225. Furthermore, the quantized data information is provided to the monitor circuit 227 via the transfer circuit 226. The information used for the transfer is matched, as restore information, to part of the restore-transfer information b.

The restore information which is used for the transfer of the quantized data and which is stored in the restore-transfer information b is preset by the control unit 50.

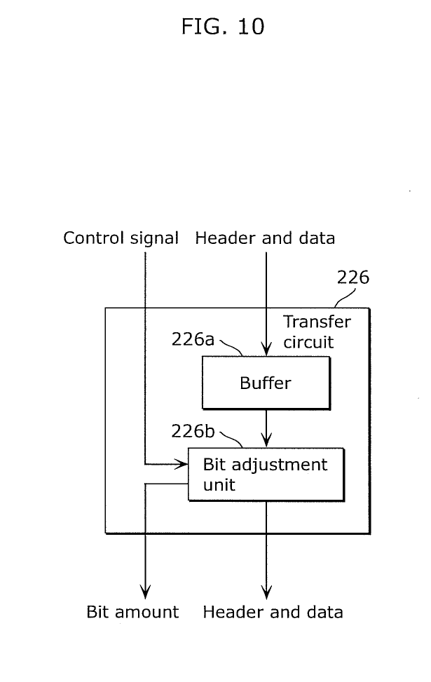

FIG. 10 is a block diagram schematically showing a configuration of the transfer circuit 226 in the header and data connection circuit 223 shown in FIG. 9.

The transfer circuit 226 temporarily stores the intermediate data, such as the headers or the quantized data, to be output to the second processing unit 221 in the internal buffer 226a in the data amount suitable for transfer from the main memory 20, according to the control signal input from the control circuit 225. More specifically, the transfer circuit 226 adjusts a unit of output, such as bit or byte, so that the intermediate data is output to the second processing unit 221 in synchronization with the address and the control signal output from the control circuit 225.

Furthermore, in the case where a given header is transferred from the main memory 20, the header is larger than the unit of transfer and part of the header which is near the end of the header is missing, a bit adjustment unit 226b performs the following processing, for example.

The bit adjustment unit 226b temporarily saves the header in an internal buffer 226a till a subsequent header is transferred from the main memory 20. Accordingly, in the case where the subsequent header is input and the end of the header saved in the buffer 226a and the subsequent header are successive, it is possible to output the header as it is.

Furthermore, for example, when meaningless data is added to a header and transferred from the main memory 20, the bit adjustment unit 226b performs the following processing.

By referring to the restore-transfer information a, the bit adjustment unit 226b refers to the bit amount of the header measured in the preceding unit 210, detects the end of the header, separates the meaningless data and discard the separated meaningless data. The bit adjustment unit 226b further connects the header thus obtained to the initial portion of a subsequent header to be transferred from the main memory 20.

Here, in any cases, the bit adjustment unit 226b provides, to the monitor circuit 227 for each data transfer, the amount of data transferred from the main memory 20 as bit amount information, for example.

The transfer circuit 226 keeps, for each data transfer, information indicating how the header is being transferred, in such a manner.

Accordingly, it is possible to match the header obtained by the transfer circuit 226 from the main memory 20 and information of all the variable-length coded headers generated by the first processing unit 211. This allows the headers for a predetermined unit and the quantized data items for the predetermined unit to be connected.

Descriptions have been given above of the control performed by the transfer circuit 226 when headers are transferred. The similar control is performed when quantized data is transferred.

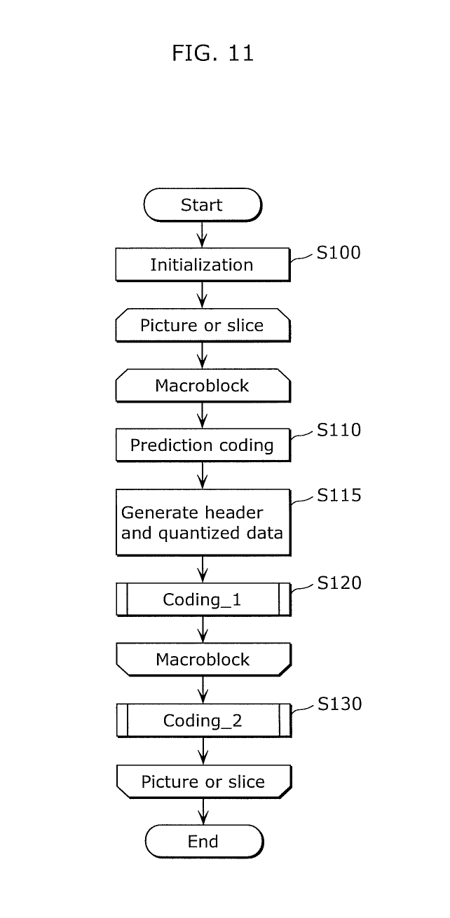

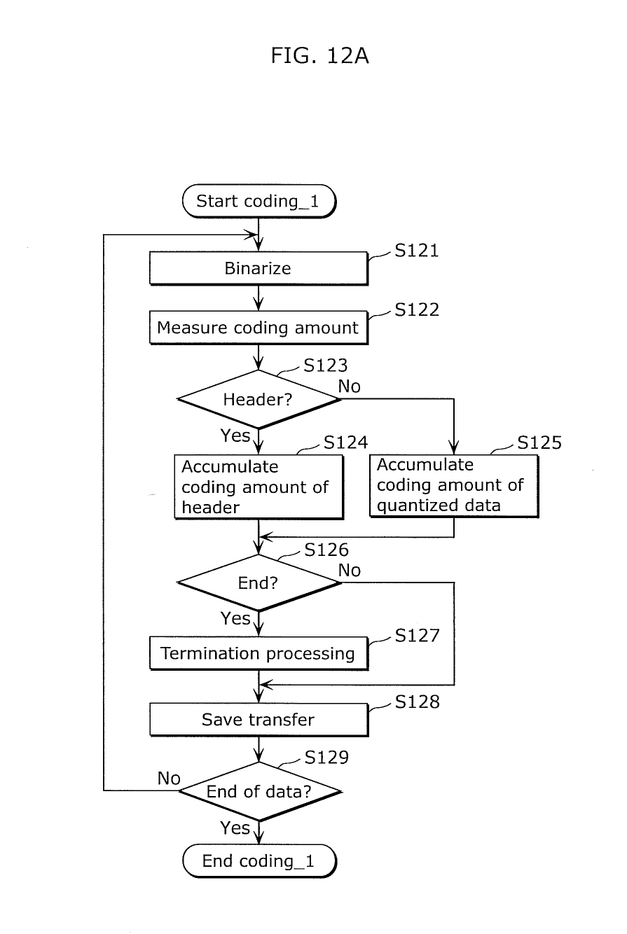

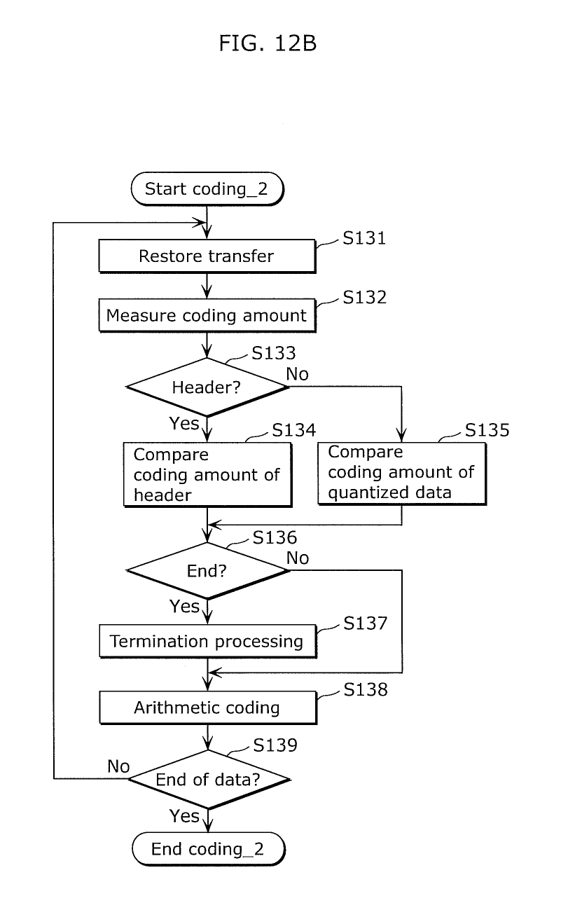

Referring to the flowcharts in FIG. 11 to FIG. 12B, a description is given of the flow of processing performed by the image coding unit 100 which includes the stream generation apparatus 200 according to Embodiment 1 described above.

FIG. 11 is a flowchart of an example of processing performed by the image coding unit 100 according to Embodiment 1.

First, an image size, a frame rate, a bit rate and others serving as parameters used for image coding are preset (S100). After the preset, image data is input to the image coding unit 100.

The input image data is repeatedly processed on a per-predetermined unit basis, such as a picture or a slice. For example, coding is performed on a per-block basis, such as a macroblock, and the intermediate data generated by the coding is transformed into stream data.

For example, the intra prediction and the inter prediction described above are performed on a per-macroblock basis (S110). Furthermore, quantized data is generated by frequency transform and quantization, and a header necessary for decoding is generated (S115).

The header and the quantized data thus generated are input to the stream generation apparatus 200, and coding_1 is performed on the header and the quantized data (S120), in the coding_1, the first processing unit 211 performs the first processing on the header and the quantized data, and the first transfer control unit 212 transfers the header and the quantized data on which the first processing has been performed to the main memory 20.

For example, when the coding_1 is completed for all the macroblocks in one picture (S120), the stream generation apparatus 200 performs coding_2 (S130).

In the coding_2, the second transfer control unit 222 obtains the headers and quantized data items for the one picture, and the second processing unit 221 performs the second processing on the headers and the quantized data items for the one picture.

As a result, the stream generation apparatus 200 outputs a stream having a data structure shown in FIG. 4, for example.

FIG. 12A is a flowchart of an example of processing in coding_1 shown in FIG. 11.

The first processing unit 211 in the preceding unit 210 performs binarization (S121) for arithmetic coding to be performed in the subsequent unit 220, and measures the coding amount generated in the binarization (S122).

When a header is processed (Yes in S123), the measurement result is accumulated as the coding amount of the header (S124). When quantized data is processed (No in S123), the measurement result is accumulated as the coding amount of the quantized data (S125).

When the end of the header or the end of the quantized data for a macroblock is processed (Yes in S126), for example, the first transfer control unit 212 performs termination processing on the end for connecting to a subsequent header or subsequent quantized data (S127).

The first transfer control unit 212 further saves the binarized header or binarized quantized data in the main memory 20 (S128). Subsequently, for example, when there is no more data to be transferred to the main memory 20 (Yes in S129), the coding_1 ends.

FIG. 12B is a flowchart of an example of processing in coding_2 shown in FIG. 11.

The second transfer control unit 222 in the subsequent unit 220 restores the intermediate data generated for arithmetic coding from the main memory 20 (S131). More specifically, the intermediate data is obtained from the main memory 20.

The second transfer control unit 222 measures the coding amount of the obtained intermediate data (S132), and when headers are processed (Yes in S133), compares the measurement result with the total coding amount of the headers (S134). When quantized data is processed (No in S133), the second transfer control unit 222 compares the measurement result with the total coding amount of the quantized data (S135).

These total coding amounts are obtained by referring to the restore-transfer information a and the restore-transfer information b.

When the second transfer control unit 222 detects from the comparison result that the end of the header or the end of the quantized data is to be processed (Yes in S136), the second transfer control unit 222 performs termination processing (S137).

Furthermore, the second transfer control unit 222 connects headers and quantized data so that headers for one picture and quantized data corresponding to the headers are successive, for example.

The connected data is input to the second processing unit 221 from the second transfer control unit 222, and the second processing unit 221 performs arithmetic coding on the input data (S138). As a result, for example, a stream having a data structure shown in FIG. 4, for example is generated.

Subsequently, for example, when there is no more data to be arithmetic coded (Yes in S139), the coding_2 ends.

In such a manner, in the stream generation apparatus 200 according to Embodiment 1, the first processing unit 211 in the preceding unit 210 performs variable-length coding on the input headers and quantized data, and the second processing unit 221 in the subsequent unit 220 performs compression coding on the variable-length coded headers and quantized data. More specifically, binarization is performed as variable-length coding, and arithmetic coding is performed as compression coding.

Furthermore, when intermediate data (binarized headers and quantized data) for arithmetic coding is transferred from the preceding unit 210 to be saved in the main memory 20, the first transfer control unit 212 stores the headers and the quantized data into different storage areas.

Hence, the second transfer control unit 222 in the subsequent unit 220 is capable of separately obtaining the headers and the quantized data items for a predetermined unit. As a result, the second processing unit 221 is capable of performing arithmetic coding on the data in which the quantized data items for a predetermined unit is connected to the end of the headers for the predetermined unit.

More specifically, the second processing unit 221 is capable of generating a stream on which data partitioning has been performed, as shown in FIG. 4.

### Embodiment 2

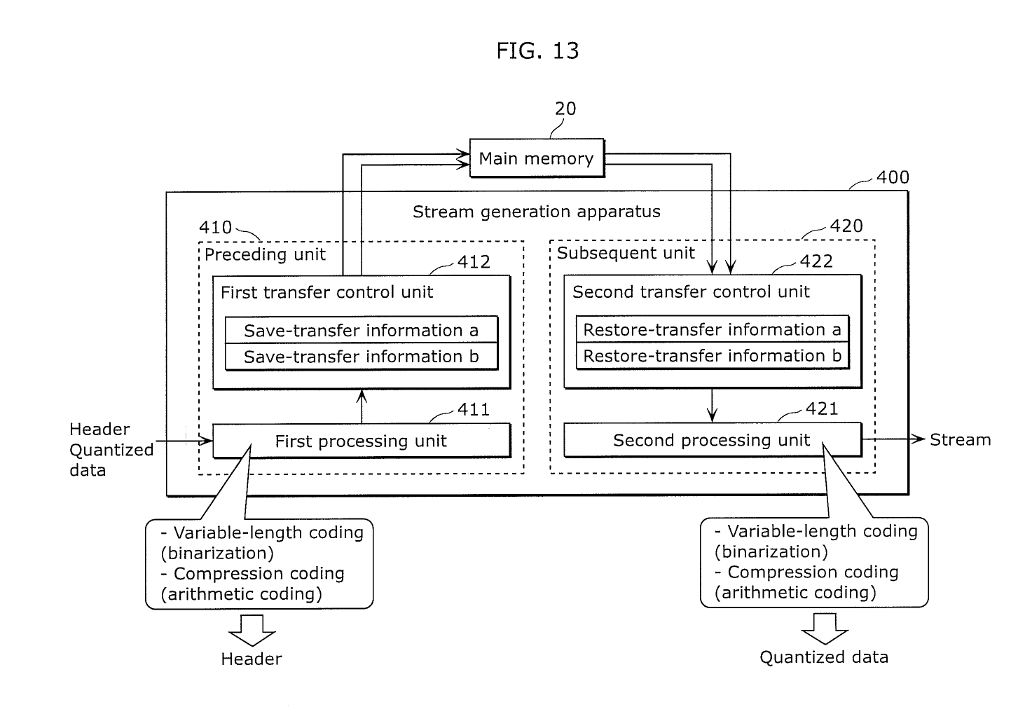

FIG. 13 is a block diagram schematically showing a configuration of a stream generation apparatus 400 according to Embodiment 2.

The stream generation apparatus 400 according to

Embodiment 2 is an apparatus which generates a stream on which data partitioning has been performed by performing variable-length coding and compression coding on image data, in the similar manner to the stream generation apparatus 200 according to Embodiment 1.

As the variable-length coding and the compression coding in Embodiment 2, binarization and arithmetic coding are used as in Embodiment 1.

Furthermore, the stream generation apparatus 400 is an apparatus which can be replaced with the stream generation apparatus 200 in the image coding unit 100 shown in FIG. 2, for example.

The functional configuration of the stream generation apparatus 400 according to Embodiment 2 is similar to that of the stream generation apparatus 200 according to Embodiment 1, as shown in FIG. 13.

Specifically, the stream generation apparatus 400 includes a preceding unit 410 and a subsequent unit 420. The preceding unit 410 includes a first processing unit 411 and a first transfer control unit 412. The subsequent unit 420 includes a second processing unit 421 and a second transfer control unit 422.

The processing performed by the first processing unit 411 and the second processing unit 421 according to Embodiment 2 is different from that performed by the first processing unit 211 and the second processing unit 221 according to Embodiment 1.

More specifically, the first processing unit 411 performs first processing including (i) variable-length coding and compression coding on headers and (ii) inputting quantized data to the first transfer control unit 412.

In other words, the first processing unit 411 performs processing up to and including arithmetic coding on headers, but does not perform binarization and arithmetic coding on quantized data and basically inputs the quantized data as it is to the first transfer control unit 412.

The second processing unit 421 performs second processing including (i) receiving the headers, which are for a predetermined unit and on which processing up to and including arithmetic coding has been performed, from the second transfer control unit 422, and (ii) variable-length coding and compression coding on the quantized data items, for the predetermined unit, obtained by the second transfer control unit 422.

The second processing unit 421 also generates a stream using first coded data and second coded data that are obtained by the second processing. The first coded data is the headers which are for the predetermined unit and on which variable-length coding and compression coding have been performed. The second coded data is quantized data items which are for the predetermined unit and on which variable-length coding and compression coding have been performed.

More specifically, since the headers have undergone the processing up to and including arithmetic coding, the second processing unit 421 performs binarization and arithmetic coding on the quantized data.

Such a configuration of the stream generation apparatus 400 according to Embodiment 2 allows generation of a stream, as shown in FIG. 4, on which data partitioning has been performed.

Each of the first processing unit 411 and the second processing unit 421 performs binarization and arithmetic coding. The binary data generated by the processing is saved in, for example, areas other than the first storage area and the second storage area in the main memory 20 or the internal storage area of the stream generation apparatus 400 (not shown).

The basic flow of processing performed by the image coding unit 100 when the stream generation apparatus 400 is included is the same as that shown in FIG. 11. For example, coding_1 is performed on a per-macroblock basis, and coding_2 is performed on a per-slice or per-picture basis.

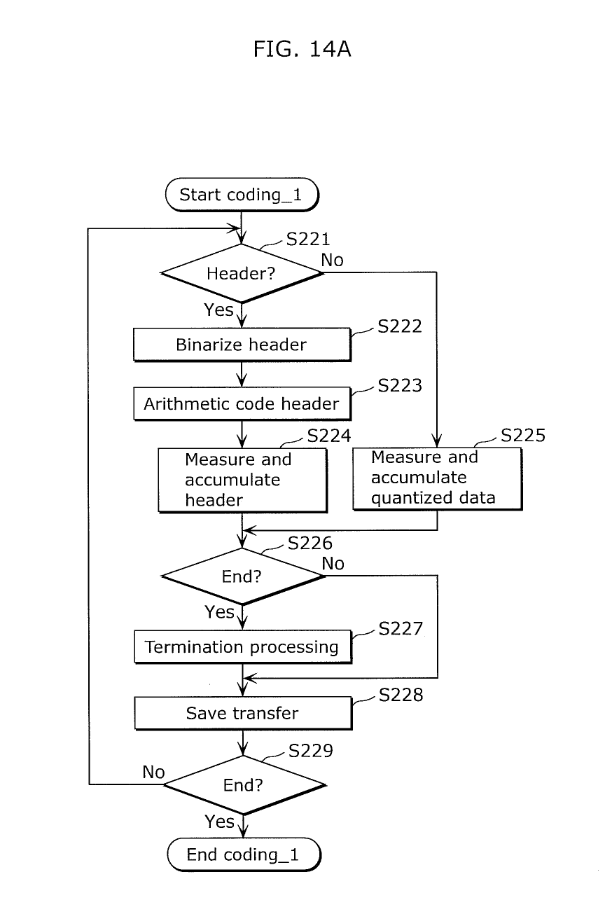

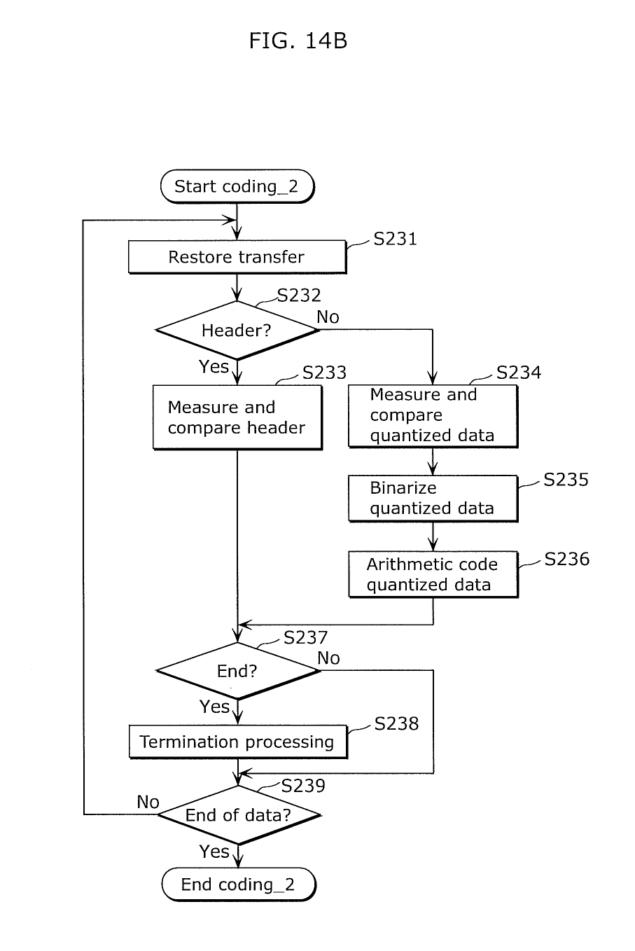

However, details of coding_1 and coding_2 in Embodiment 2 are different from those in Embodiment 1. Now, a description is given of the flow of processing in the coding_1 and the coding_2 according to Embodiment 2, referring to FIG. 14A and FIG. 14B.

FIG. 14A is a flowchart of an example of processing in the coding_1 according to Embodiment 2.

When headers are processed (Yes in S221), the first processing unit 411 performs binarization and arithmetic coding on headers for a predetermined unit, such as a picture, for example, (S222 and S223), and measures and stores the coding amount of the stream data as the arithmetic coded headers (S224).

On the other hand, when quantized data is processed (No in S221), no processing such as coding is performed and the coding amount of the quantized data is measured for storage (S225).

The headers, on which processing up to and including arithmetic coding have been performed, and the quantized data, on which coding and the like have not been performed, are input from the first processing unit 411 to the first transfer control unit 412.

After the processing of S222 to S224 or of S225, in the case where the first transfer control unit 412 detects that the end of the header or the end of the quantized data is processed (Yes in S226), the first transfer control unit 412 performs termination processing on the end for connecting to a subsequent header or subsequent quantized data (S227).

Subsequently, the first transfer control unit 412 saves, in the main memory 20, intermediate data that is headers, which are for a predetermined unit and on which processing up to and including arithmetic coding has been performed, or quantized data on which coding and the like have not been performed (S228).

The save processing, that is, the transfer of the intermediate data to the main memory 20, is performed according to the save-transfer information a and the save-transfer information b, in the same manner as Embodiment 1. Furthermore, the save-transfer information a and the save-transfer information b are set by the control unit 50 in the same manner as Embodiment 1, Hence, descriptions of the save-transfer information a and the save-transfer information b are omitted here.

Specifically, the headers after the first processing, that is, headers on which processing up to and including arithmetic coding has been performed, are stored in the first storage area by the transfer. Furthermore, the quantized data after the first processing, that is, the quantized data input from the first processing unit 411 to the first transfer control unit 412 without processing such as coding, is stored in the second storage area by the transfer.

Subsequently, for example, when there is no more data to be transferred to the main memory 20 (Yes in S229), coding_1 ends.

FIG. 14B is a flowchart of an example of processing in the coding_2 according to Embodiment 2.

The second transfer control unit 422 in the subsequent unit 420 restores the intermediate data saved in the main memory 20, from the main memory (S231). More specifically, the intermediate data is obtained from the main memory 20.

When the obtained intermediate data is headers (Yes in S232), the second transfer control unit 422 performs measurement and comparison of the coding amount on the headers (S233), and outputs the resultant to the second processing unit 421.

When the obtained intermediate data is quantized data (No in S232), the second transfer control unit 422 performs measurement and comparison of the coding amount on the quantized data (S234), and outputs the resultant to the second processing unit 421.

The restore processing, that is, the transfer of the intermediate data from the main memory 20 is performed according to the restore-transfer information a and the restore-transfer information b, in the same manner as Embodiment 1. Furthermore, the restore-transfer information a and the restore-transfer information b are set by the control unit 50 in the same manner as Embodiment 1. Hence, descriptions of the restore-transfer information a and the restore-transfer information b are omitted here.

The second processing unit 421 performs binarization on the quantized data items, obtained form the second processing unit 421, for a predetermined unit such as a picture (S235), and further performs arithmetic coding on the binarized quantized data (S236).

When the second processing unit 421 detects the end of the arithmetic coded header, based on the result of the comparison (S233 and S234) performed by the second transfer control unit 422 (Yes in S237), the second processing unit 421 performs termination processing on the end for connecting to subsequent quantized data (S238). In the similar manner, when the end of the arithmetic coded quantized data is detected (Yes in S237), the termination processing is performed on the end (S238).

The thus obtained headers and quantized data items, which are for the predetermined unit and on which processing up to and including arithmetic coding has been performed, are connected by the second processing unit 421. As a result, for example, a stream having a data structure shown in FIG. 4 is generated.

Subsequently, for example, when there is no more data to be arithmetic coded (Yes in S239), the coding_2 ends.

In such a manner, in the stream generation apparatus 400 according to Embodiment 2, the first processing unit 411 in the preceding unit 410 performs variable-length coding and compression coding on the headers, and second processing unit 421 in the subsequent unit 420 performs variable-length coding and compression coding on the quantized data.

More specifically, binarization is performed as variable-length coding, and arithmetic coding is performed as compression coding.

When the intermediate data according to Embodiment 2 (the arithmetic coded headers, and the quantized data on which processing such as coding has not been performed) is transferred from the preceding unit 410 to be saved in the main memory 20, the first transfer control unit 412 stores the headers and the quantized data in separate storage areas.

Accordingly, the second transfer control unit 422 in the subsequent unit 420 is capable of separately obtaining the headers and the quantized data items for a predetermined unit. As a result, the second processing unit 421 is capable of generating a stream including arithmetic coded headers for a predetermined unit followed by the arithmetic coded quantized data items for the predetermined unit.

More specifically, the second processing unit 221 is capable of generating a stream on which data partitioning has been performed, as shown in FIG. 4.

(Supplementary Note for Embodiment 1 and Embodiment 2)

In Embodiment 1 and Embodiment 2, the first storage area for storing headers and the second storage area for storing quantized data are included in a single memory (the main memory 20) (See FIG. 8).

However, it may be that the first storage area and the second storage area are included in physically different memories.

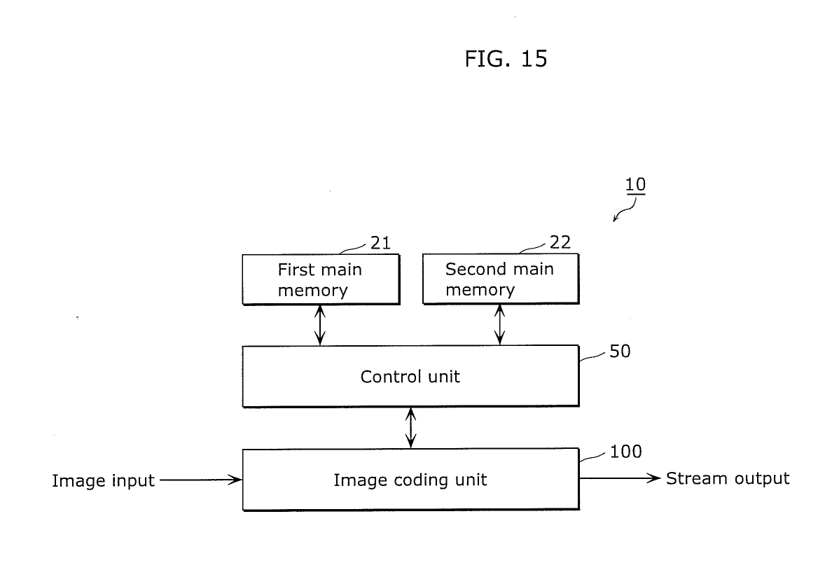

FIG. 15 is a block diagram schematically showing a configuration of a case where the image coding apparatus 10 according to Embodiment 1 includes the first storage area and the second storage area in physically different memories.

More specifically, the image coding unit 100 is connected to a first main memory 21 and a second main memory 22 via the control unit 50.

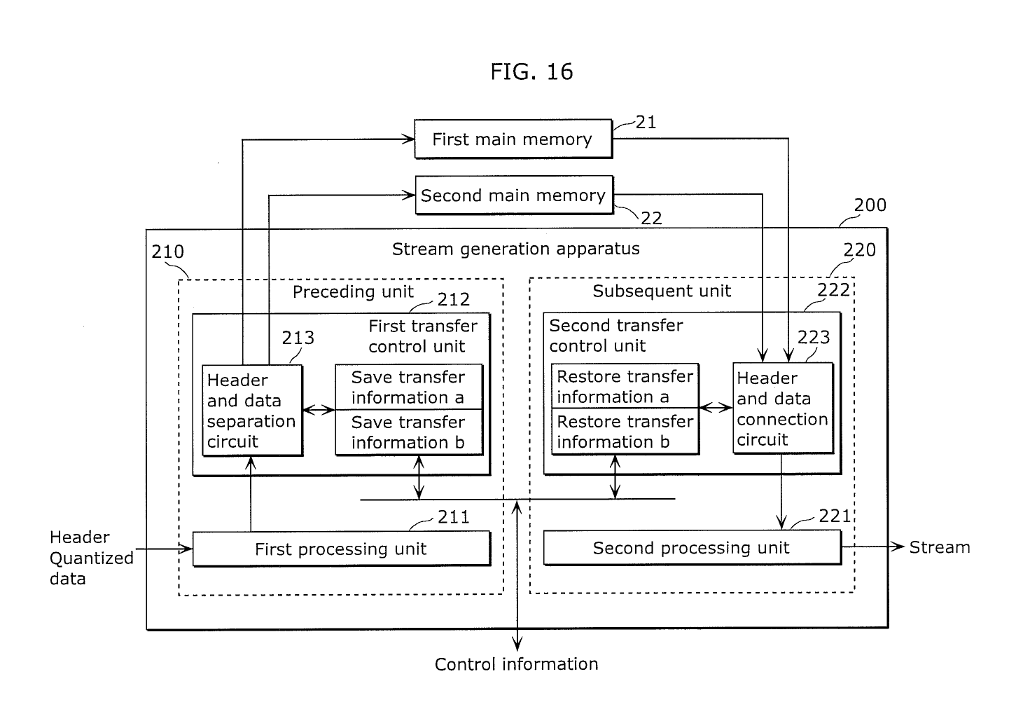

FIG. 16 is a block diagram schematically showing a configuration of a case where the image coding unit 100 according to Embodiment 1 is connected to the first main memory 21 and the second main memory 22.

In FIG. 16, for example, the first main memory 21 includes a first storage area, and the second main memory 22 includes a second storage area. Specifically, the storage unit used by the stream generation apparatus 200 includes the first main memory 21 and the second main memory 22.

More specifically, the headers output from the first transfer control unit 212 are stored in the first main memory 21. The quantized data output from the first transfer control unit 212 is stored in the second main memory 22.

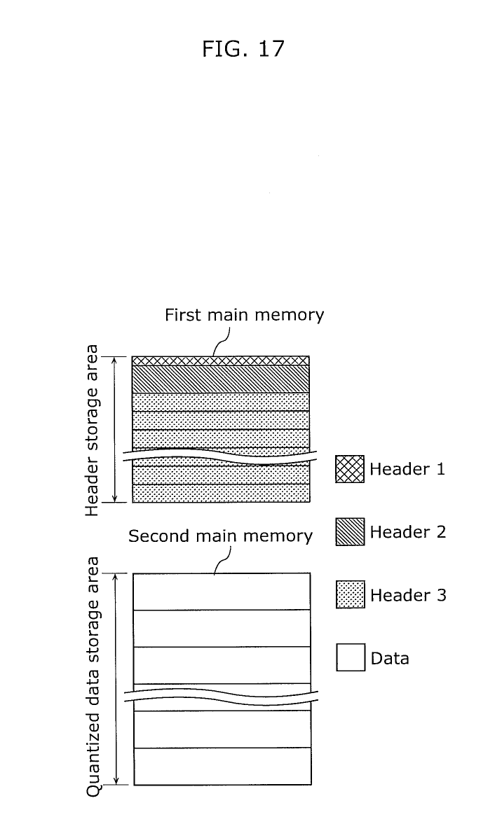

FIG. 17 shows an example of mapping of the first main memory 21 and mapping of the second main memory 22 shown in FIG. 16.

As shown in FIG. 17, various types of headers are collectively stored in the first main memory 21, and quantized data items are collectively stored in the second main memory 22 that is physically different from the first main memory 21.

As described above, even when two storage areas used by the stream generation apparatus 200 or 400 for saving intermediate data exist in two physically different memories, it is possible to obtain the advantageous effects similar to the case where the storage areas exist in a single memory. More specifically, it is possible to separately process the headers and quantized data easily in the stream generation process. As a result, it is possible to generate a stream on which arithmetic coding and data partitioning have been performed.

The transfer of the headers and quantized data to respective memories is controlled in the similar manner to Embodiment 1 and Embodiment 2. More specifically, headers and quantized data are transferred according to the save-transfer information a and the save-transfer information b including information such as addresses in the first main memory 21 and the second main memory 22.

Furthermore, the stream generation apparatus 200 according to Embodiment 1 and the stream generation apparatus 400 according to Embodiment 2 may be used as an apparatus for generating a stream, in various systems in which image data coding is performed.

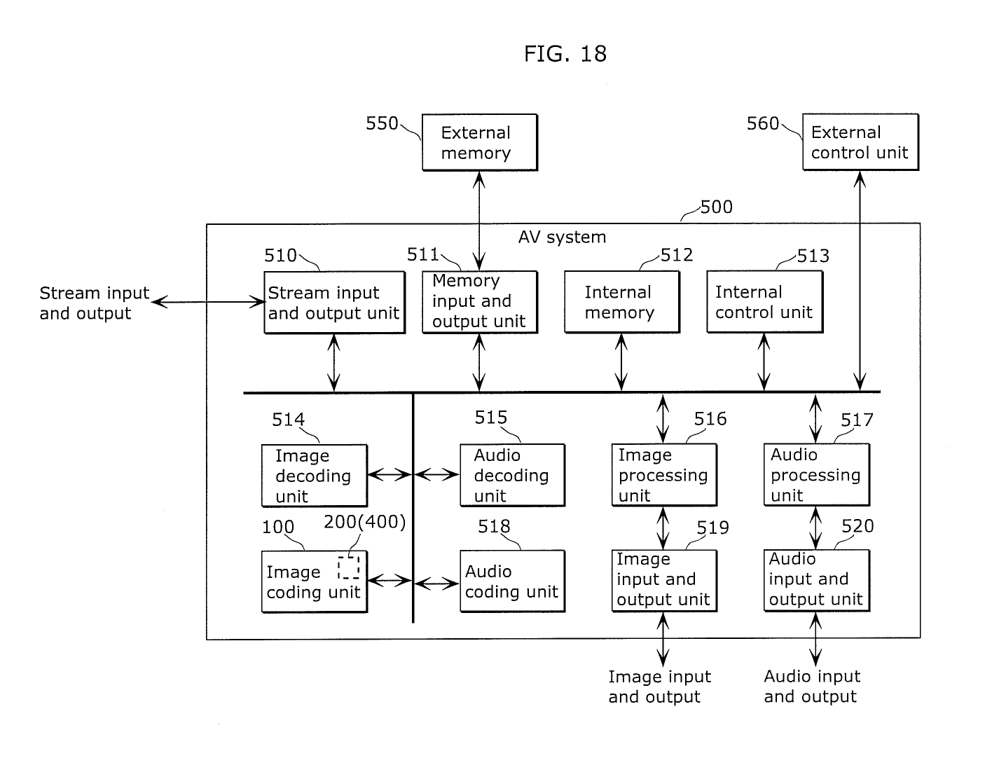

FIG. 18 is an example of a configuration of an audio visual (AV) system 500 which includes the stream generation apparatus 200 according to Embodiment 1 or the stream generation apparatus 400 according to Embodiment 2.

The AV system 500 includes a stream input and output unit 510, a memory input and output unit 511, an internal memory 512, an internal control unit 513, an image decoding unit 514, an audio decoding unit 515, an image processing unit 516, an audio processing unit 517, an audio coding unit 518, an image input and output unit 519, an audio input and output unit 520, and the image coding unit 100.

The AV system 500 is connected to an external memory 550, and is capable of transmitting and receiving data to and from the external memory 550. The AV system 500 is also capable of operating according to a control signal from an external control unit 560.

The image coding unit 100 is an apparatus which includes the stream generation apparatus 200 or 400, and the configuration of the image coding unit 100 is, for example, as shown in FIG. 2.

The image coding unit 100 is connected to other functional blocks via a bus to allow transmission and receipt of data, control signals and others. The stream generation apparatus 200 or 400 may use the external memory 550 or the internal memory 512 as a memory for saving intermediate data.

When the external memory 550 is used for saving the intermediate data, part of the functions of the control unit 50 (see FIG. 1) is performed by the memory input and output unit 511.

The external control unit 560 or the internal control unit 513 may directly control operations of the stream generation apparatuses 200 and 400.

With such configuration, in the AV system 500, the image coding unit 100 including the stream generation apparatus 200 or 400 is capable of generating a stream to which arithmetic coding and data partitioning have been applied, relative to image data input from the image input and output unit 519, for example. The generated stream is output from the stream input and output unit 510, and is received by an external playback apparatus via the Internet, for example.

Descriptions have been given of the stream generation apparatus and the stream generation method according to the present invention based on Embodiment 1 and Embodiment 2. However, the present invention is not limited to such embodiments and the supplemental note thereof.

Those skilled in the art will readily appreciate that various modifications and combinations may be made in these exemplary embodiments and the supplementary note without materially departing from the principles and spirit of the inventive concept, the scope of which is defined in the appended Claims and their equivalents.

For example, in Embodiments 1 and 2, descriptions have been given of the case where the stream generation apparatuses 200 and 400 perform arithmetic coding involving data partitioning. However, the present invention is not limited to the example.

More specifically, even if an apparatus is not intended to have a technique referred to as “data partitioning”, but the apparatus stores headers and quantized data in different areas in the stream and generates the stream by performing processing after quantization in two stages, one or more exemplary embodiments or features disclosed herein is applicable to such an apparatus.

Furthermore, in Embodiments 1 and 2, binarization is used as variable-length coding, and arithmetic coding is used as compression coding. However, the present invention is not limited to the example.

For example, in coding processing where processing after quantization is performed in two stages, one or more exemplary embodiments or features disclosed herein is applicable if an apparatus performs variable-length coding on data in the preceding stage, and a set of coding processing where a predetermined amount of processing results of the preceding stage is collectively compressed in the subsequent stage.

Furthermore, when generating a stream, the stream generation apparatuses 200 and 400 may embed other useful information for decoding in the stream.

For example, information indicating the boundary position between the first coded data and the second coded data may be embedded in a header in a non-arithmetic coding section at the beginning of the stream.

More specifically, in the initial header of the stream, the positional information may be embedded which indicates the beginning position of the second coded data in the stream.

Accordingly, the image decoding apparatus which receives and decodes the stream is capable of easily and instantly obtaining information for separating the first coded data and the second coded data, by reading the positional information from the initial header in the stream.

As a result, the image decoding apparatus is capable of performing efficient processing such as performing decoding on the first coded data and the second coded data in parallel, for example.

A description will be given of a stream processing apparatus which efficiently performs decoding using the positional information in the stream, in Embodiment 4.

### Embodiment 3

Next, as Embodiment 3, a description is given of an image decoding apparatus which decodes a stream on which variable-length coding, compression coding, and data partitioning have been performed.

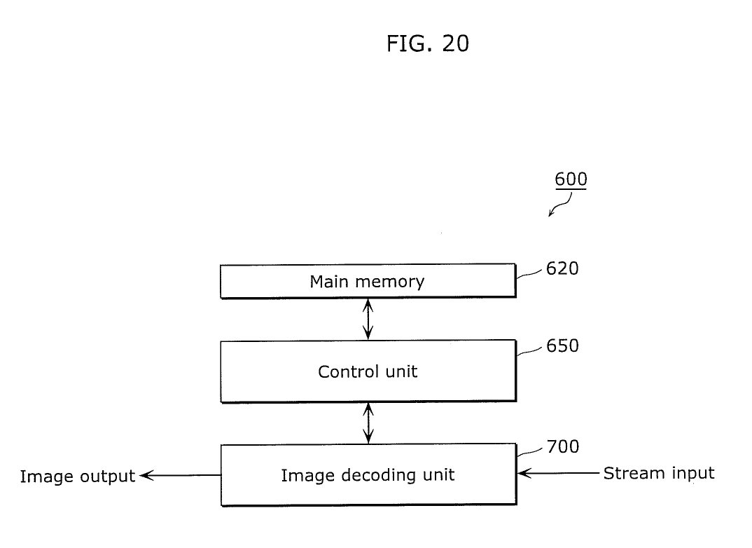

FIG. 20 is a block diagram schematically showing a configuration of an image decoding apparatus 600 according to Embodiment 3.

As shown in FIG. 20, the image decoding apparatus 600 includes an image decoding unit 700, a control unit 650, and a main memory 620.

The main memory 620 is a memory (for example, DRAM) for storing data.

The control unit 650 includes, for example, a processor such as a central processing unit (CPU) (not shown), and a memory control circuit (not shown).

In the image decoding apparatus 600, the image decoding unit 700 performs decoding on an input stream while saving and restoring intermediate data via the control unit 650, using the main memory 620 provided outside the image decoding unit 700. The image decoding unit 700 outputs an image obtained by the decoding.

The control unit 650 controls not only the transfer of data between the image decoding unit 700 and the main memory 620, but also controls the image decoding unit 700.

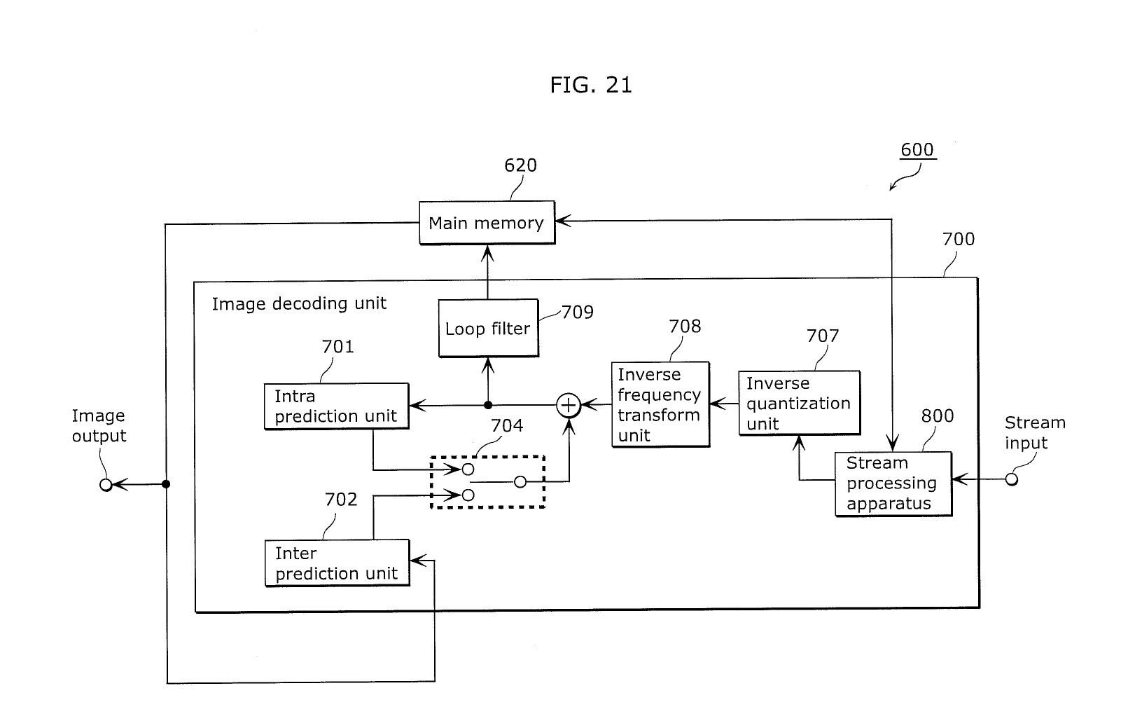

FIG. 21 is a block diagram schematically showing a configuration of the image decoding unit 700 according to Embodiment 3.

Referring to FIG. 21, a description is given of basic processing performed by the image decoding unit 700. The control unit 650 shown in FIG. 20 is not shown in FIG. 21.

The image decoding unit 700 receives a stream generated by performing variable-length coding and compression coding in this order on quantized data which is quantized image data and headers corresponding to the quantized data.

The stream includes the first coded data that is headers for a predetermined unit followed by second coded data that is quantized data items for the predetermined unit. Specifically, data partitioning has been performed on the stream.

In Embodiment 3, the image decoding unit 700 receives a stream generated by the image coding apparatus 10 according to Embodiment 1 or 2, for example. Specifically, the image decoding unit 700 receives a stream on which both arithmetic coding and data partitioning have been performed.

A stream processing apparatus 800 performs decompression decoding and variable-length decoding on the stream input to the image decoding unit 700.

In Embodiment 3, the stream processing apparatus 800 performs, on the input stream, arithmetic decoding that is an example of decompression decoding, and debinarization that is an example of variable-length decoding.

The data output from the stream processing apparatus 800 is processed by an inverse quantization unit 707 and an inverse frequency transform unit 708. Accordingly, the data is restored to the difference image data which is an input source or data approximating to the difference image data. The restored data, and prediction image data which is input from a switch 704 and corresponds to the restored data are combined to generate a reconstructed image.

The switch 704 selects one of an intra prediction unit 701 and an inter prediction unit 702 according to which one of the intra prediction and inter prediction has been used for a current picture to be decoded.

The generated reconstructed image or the reconstructed image on which deblocking has been applied by a loop filter 709 is saved in the main memory 620, and the image is read from the main memory 620 when inter prediction is performed.

The decoded image stored in the main memory 620 is output to a video display apparatus, such as a television, and displayed on the video display apparatus.

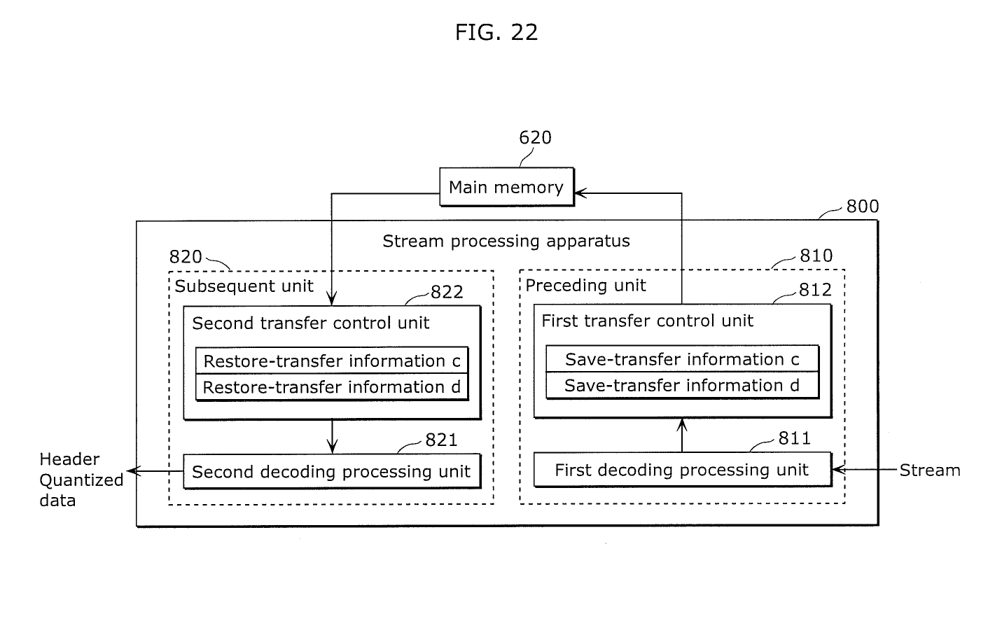

FIG. 22 is a block diagram schematically showing a configuration of the stream processing apparatus 800 according to Embodiment 3.

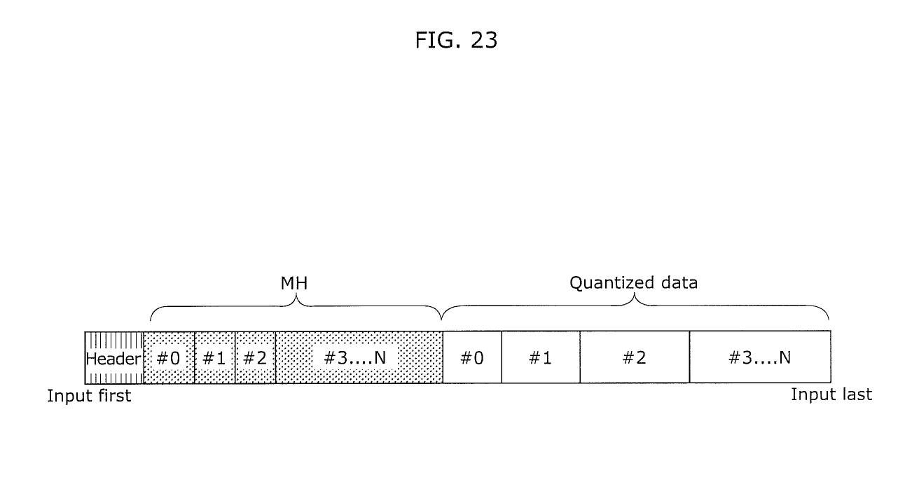

FIG. 23 is a diagram showing an example of a data structure of a stream input to the stream processing apparatus 800 according to Embodiment 3. The stream shown in FIG. 23 is a stream obtained by variable-length coding and compression coding, and is an example of a stream to which data partitioning has been applied. For example, the stream is generated by the image coding apparatus 10 according to Embodiment 1 or 2.

The stream processing apparatus 800 includes a preceding unit 810 and a subsequent unit 820. Each of the preceding unit 810 and the subsequent unit 820 is capable of communicating with the main memory 620 which is an example of a storage unit and which is connected to the stream processing apparatus 800.

The stream processing apparatus 800 according to Embodiment 3 performs arithmetic decoding and debinarization on the input stream, and outputs the headers and quantized data which are in a state before binarization and arithmetic coding are performed.

The arithmetic decoding is performed on a per-slice or per-picture basis, which is a unit larger than a macroblock or a block.

The stream processing apparatus 800 according to Embodiment 3 temporarily saves, in the main memory 620, intermediate data on which decoding processing has been performed in the preceding unit 810, and restores the intermediate data from the main memory 620 when the subsequent unit 820 performs decoding.

More specifically, the preceding unit 810 includes a first decoding processing unit 811 and a first transfer control unit 812. The first decoding processing unit 811 performs first decoding processing on the input stream. The first decoding processing includes at least decompression decoding on the second coded data.

In FIG. 23, a set of macroblock headers of #0 to #N is an example of the first coded data, and a set of quantized data items of #0 to #N is an example of the second coded data. The initial header (the leftmost header in FIG. 23) in the stream shown in FIG. 23 is, for example, a picture header which corresponds to the macroblock header set and the quantized data set.

The first transfer control unit 812 transfers first data which is the first coded data on which first decoding processing has been performed to a first storage area in the main memory 620, and transfers second data which is the second coded data on which the first decoding processing has been performed to a second storage area in the main memory 620.

More specifically, the first decoding processing unit 811 according to Embodiment 3 generates the first data and the second data which are intermediate data, by performing the first decoding processing which is decompression decoding (arithmetic decoding) on the first coded data and the second coded data.

The generated first data is transferred to the first storage area by the first transfer control unit 812, and the generated second data is transferred to the second storage area by the first transfer control unit 812. The first transfer control unit 812 holds at least two types of transfer control information for controlling the save processing. The first transfer control unit 812 refers to the transfer control information when performing the save processing (transfer processing).

More specifically, the first transfer control unit 812 holds save-transfer information c corresponding to the first storage area and save-transfer information d corresponding to the second storage area.

The mapping of the storage area in the main memory 620 according to Embodiment 3 is similar to that of the storage area in the main memory 20 according to Embodiment 1. More specifically, as shown in FIG. 8, the first data (headers) is stored in the first storage area, and the second data (quantized data) is stored in the second storage area.

The subsequent unit 820 includes a second decoding processing unit 821 and a second transfer control unit 822. The second transfer control unit 822 obtains the first data from the first storage area, and obtains the second data from the second storage area.

The second transfer control unit 822 also outputs each of the headers on which the first decoding processing has been performed and the quantized data on which the first decoding processing has been performed and which corresponds to the header. The headers and the quantized data are included in the obtained first data and second data, respectively.

The second transfer control unit 822 holds at least two types of transfer control information for controlling the restore processing of the first data and the second data from the main memory 620, and refers to the transfer control information when performing the restore processing (transfer processing).

More specifically, the second transfer control unit 822 holds restore-transfer information c corresponding to the first storage area and restore-transfer information d corresponding to the second storage area.

The second decoding processing unit 821 performs second decoding processing on the headers and the quantized data on which the first decoding processing has been performed and which are output from the second transfer control unit 822. The second decoding processing includes at least variable-length decoding (debinarization) on the headers.

Furthermore, the second decoding processing unit 821 successively outputs the header and the quantized data corresponding to the header obtained by the first decoding processing and the second decoding processing. The header and the quantized data are in a state before variable-length coding (binarization) and compression coding (arithmetic coding) are performed.

For example, when the stream shown in FIG. 23 is input to the stream processing apparatus 800, a pair of macroblock header #K and quantized data #K, which has been restored to multivalued data, is output from the stream processing apparatus 800 in the order from K being 0, 1, 2, . . . to N.

With such a configuration, the stream processing apparatus 800 is capable of appropriately decoding a stream to which both data partitioning and arithmetic decoding have been applied.

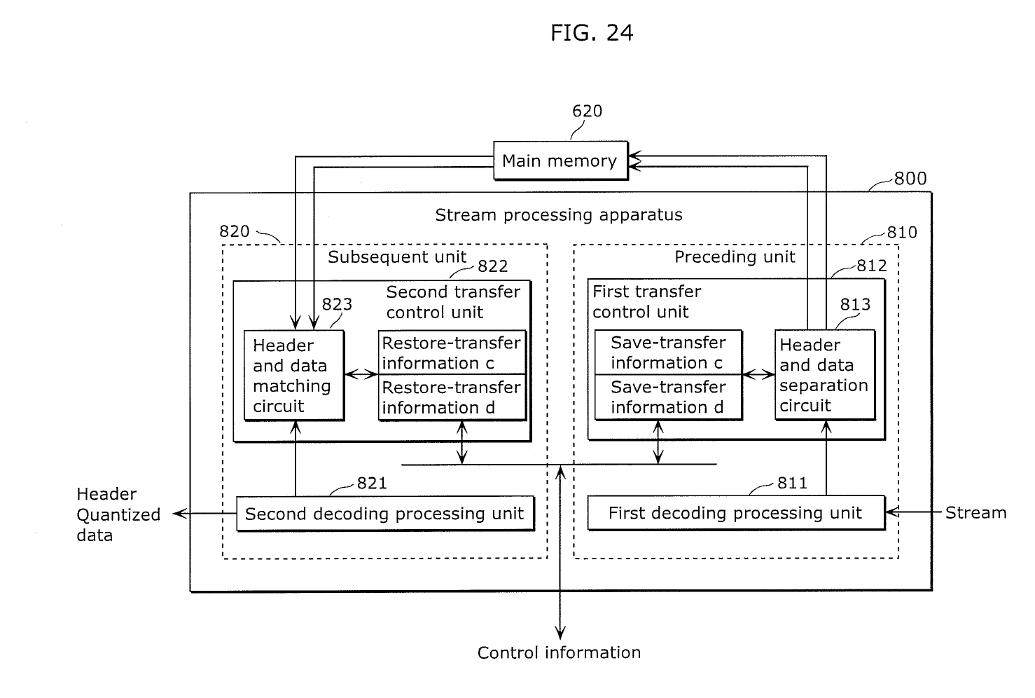

FIG. 24 is a diagram showing a detailed configuration of the first transfer control unit 812 and the second transfer control unit 822 in the stream processing apparatus 800 shown in FIG. 22.

Control information for controlling transfer of various data is preset to the first transfer control unit 812 in the preceding unit 810 by the control unit 650 which controls the operations of the image decoding unit 700, for example, as the save-transfer information c and the save-transfer information d.

In the first transfer control unit 812, a header and data separation circuit 813 separates the intermediate data input from the first decoding processing unit 811 for transfer to predetermined areas in the main memory 620, based on the information.

More specifically, the header and data separation circuit 813 obtains the first data and the second data obtained by arithmetic decoding performed by the first decoding processing unit 811. The header and data separation circuit 813 transfers the first data which is binary data to the first storage area in the main memory 620 according to the save-transfer information c. The header and data separation circuit 813 also transfers the second data which is binary data to the second storage area in the main memory 620 according to the save-transfer information d.

The save-transfer information c is an example of first address information, and for example, includes information indicating an address in the first storage area at which the first data including a plurality of headers is stored. The save-transfer information d is an example of second address information, and for example, includes information indicating an address in the second storage area at which the second data including a plurality of quantized data items is stored.

On the other hand, control information for controlling transfer of various data is preset to the second transfer control unit 822 in the subsequent unit 820 by the control unit 650 which controls the operations of the image decoding unit 700, for example, as the restore-transfer information c and the restore-transfer information d.

In the second transfer control unit 822, a header and data matching circuit 823 transfers intermediate data from predetermined areas in the main memory 620 based on the information, and performs matching processing for outputting to the second decoding processing unit 821.

More specifically, the header and data matching circuit 823 obtains the first data from the first storage area in the main memory 620 according to the restore-transfer information c. The header and data matching circuit 823 also obtains the second data corresponding to the first data from the second storage area in the main memory 620 according to the restore-transfer information d.

The restore-transfer information c includes, for example, information indicating an address in the first storage area at which the first data is stored. The restore-transfer information d includes, for example, information indicating an address in the second storage area at which the second data is stored.

The header and data matching circuit 823 inputs the obtained first data and second data corresponding to the first data to the second decoding processing unit 821. For example, a pair of a header included in the first data and the quantized data corresponding to the header and included in the second data is sequentially input to the second decoding processing unit 821.

The second decoding processing unit 821 performs debinarization on the headers and quantized data which are binary data and which are included in the input first data and second data, respectively. The second decoding processing unit 821 further sequentially outputs the headers and the quantized data corresponding to the headers which are obtained by the debinarization.

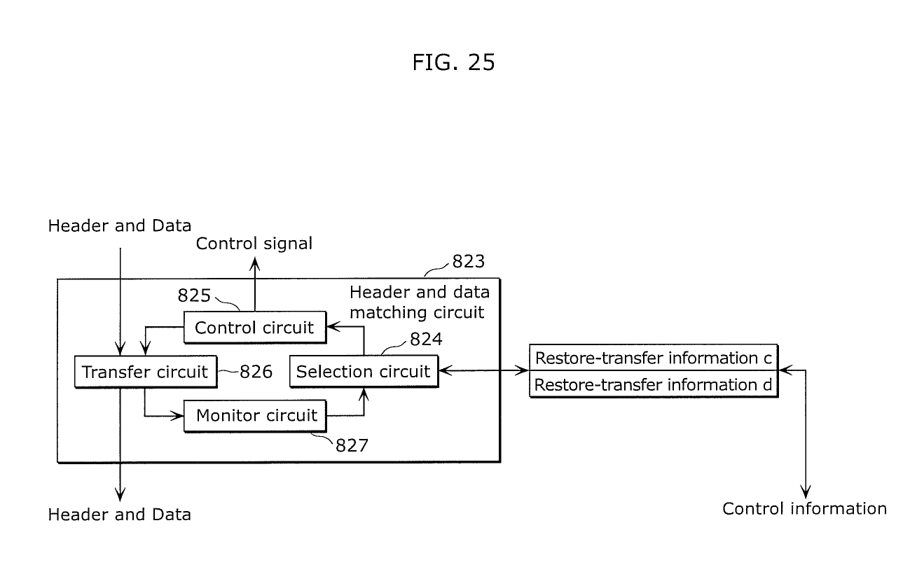

FIG. 25 is a block diagram schematically showing a configuration of the header and data matching circuit 823 in the second transfer control unit 822 shown in FIG. 24.

The header and data matching circuit 823 obtains, from the main memory 620, the intermediate data to be output to the second decoding processing unit 821, based on the information set to the restore-transfer information c and the restore-transfer information d.

More specifically, in the case where the intermediate data to be output to the second decoding processing unit 821 is headers and if the restore-transfer information c includes information to be used for transferring the intermediate data from the first storage area (such as an address at which the headers are stored), a selection circuit 824 selects the information, and provides the information to a control circuit 825.

The control circuit 825 outputs the address in the first storage area in the main memory 620 at which the headers are stored and a control signal necessary for reading. The control circuit 825 also provides, to the transfer circuit 826, a control signal for synchronization with the headers input to the transfer circuit 826.

The transfer circuit 826 obtains the headers from the main memory 620 based on the control signal input from the control circuit 825. Furthermore, the header information is provided to a monitor circuit 827 via the transfer circuit 826. The information used for the transfer is matched, as restore information, to part of the restore-transfer information c.

Subsequently, when the intermediate data to be output to the second decoding processing unit 821 is quantized data and if the restore-transfer information d includes the information to be used for the transferring the intermediate data from the second storage area, the selection circuit 824 selects the information and provides it to the control circuit 825.

The control circuit 825 outputs the address in the second storage area in the main memory 620 at which the quantized data is stored and a control signal necessary for reading. The control circuit 825 also provides, to the transfer circuit 826, a control signal for synchronization with the quantized data input to the transfer circuit 826.

The transfer circuit 826 obtains the quantized data from the main memory 620 based on the control signal input from the control circuit 825. Furthermore, the quantized data information is provided to the monitor circuit 827 via the transfer circuit 826. The information used for the transfer is matched, as restore information, to part of the restore-transfer information d.

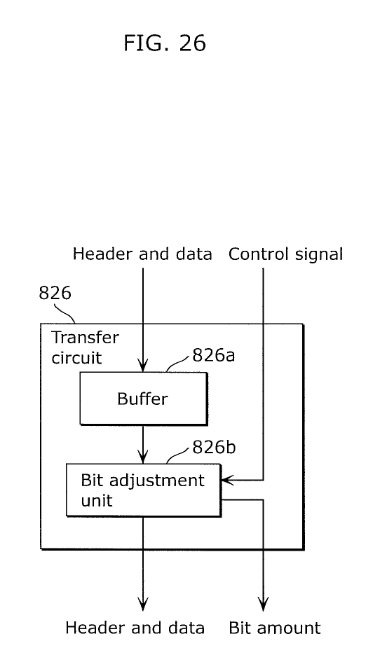

FIG. 26 is a block diagram schematically showing a configuration of the transfer circuit 826 in the header and data matching circuit 823 shown in FIG. 25.

The transfer circuit 826 temporarily stores the intermediate data to be output to the second decoding processing unit 821 in an internal buffer 826a in the data amount suitable for transfer from the main memory 620, according to the control signal input from the control circuit 825.

More specifically, the transfer circuit 826 adjusts a unit of output, such as bit or byte, so that the intermediate data is output to the second decoding processing unit 821 in synchronization with the address and the control signal output from the control circuit 825.

Furthermore, in the case where a given header is transferred from the main memory 620, the header is larger than the unit of transfer and part of the header near the end of the header is missing, a bit adjustment unit 826b performs the following processing, for example.

The bit adjustment unit 826b temporarily saves the header in the internal buffer 826a till a subsequent header is transferred from the main memory 620. Accordingly, when the subsequent header is input and the end of the header saved in the buffer 826a and the subsequent header are successive, it is possible to output the headers as they are.

Furthermore, for example, when meaningless data is added to a header and transferred from the main memory 620, the bit adjustment unit 826b performs the following processing.

By referring to the restore-transfer information c, the bit adjustment unit 826b refers to the bit amount of the header measured in the preceding unit 810 to detect the end of the header, and separates the meaningless data and discard the separated meaningless data. The bit adjustment unit 826b further connects the header thus obtained to the beginning of a subsequent header transferred from the main memory 620.

Here, in any cases, the bit adjustment unit 826b provides, to the monitor circuit 827 for each data transfer, the amount of data transferred from the main memory 620 as bit amount information, for example.

The transfer circuit 826 keeps, for each data transfer, information indicating how the header is being transferred, in such a manner.

Accordingly, it is possible to match the header obtained by the transfer circuit 826 from the main memory 620 and information of all the arithmetic decoded headers generated by the first decoding processing unit 811. This allows respective headers for a predetermined unit and the quantized data items corresponding to the headers to be matched.

Descriptions have been given above of the control performed by the transfer circuit 826 when headers are transferred. The similar control is performed when quantized data is transferred.

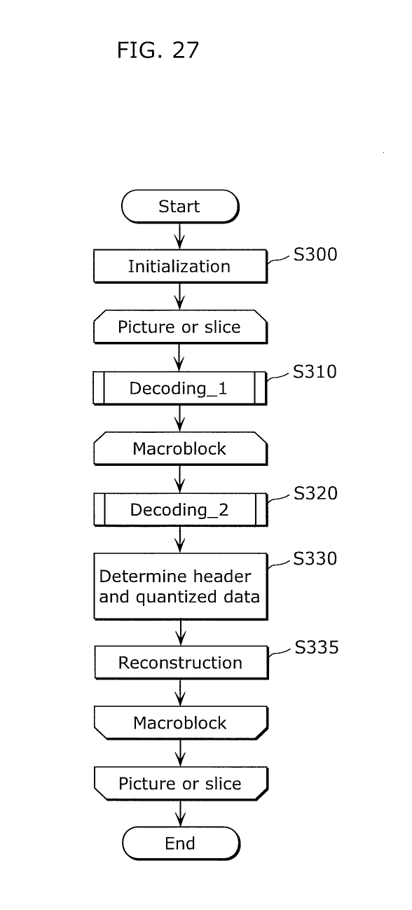

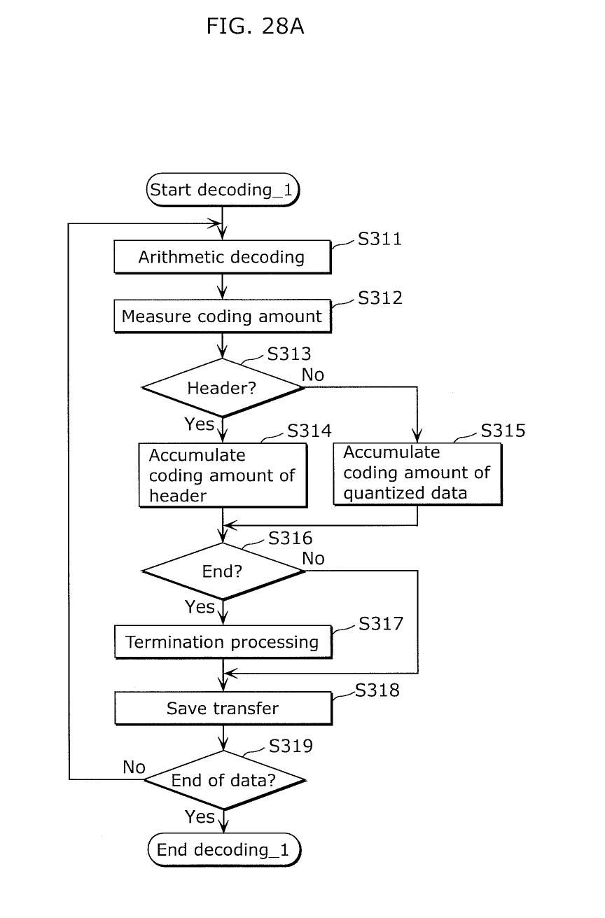

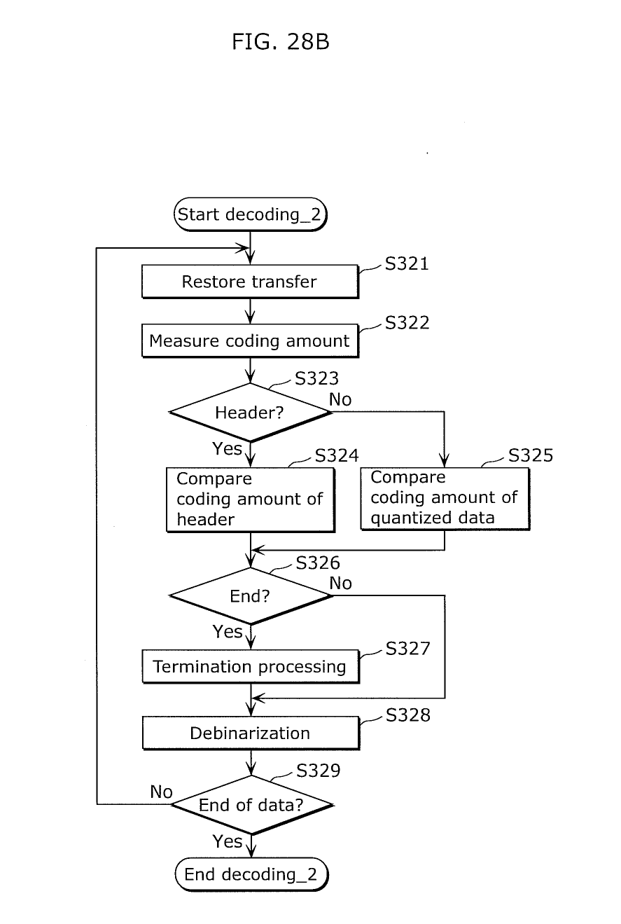

Referring to the flowcharts in FIG. 27 to FIG. 28B, a description is given of the flow of processing performed by the stream processing apparatus 800 according to Embodiment 3.

FIG. 27 is a flowchart of an example of processing performed by the stream processing apparatus 800 according to Embodiment 3.

First, various parameters, such as a coding mode, which are referred to in decoding an image is set (S300). After the setting, the stream processing apparatus 800 performs the following processing on a stream.

More specifically, the stream input to the stream processing apparatus 800 is repeatedly processed on a per-predetermined unit, such as a picture or a slice. For example, decoding is performed on a per-block basis, such as a macroblock.

For example, decoding_1 is performed on a per-picture basis (S310), and decoding_2 is performed on the intermediate data obtained by the decoding_1, on a per-macroblock basis (S320).

It is determined whether the data obtained by the decoding_2 is a header or quantized data (S330), and reconstruction processing is further performed on the data (S335). Accordingly, the stream processing apparatus 800 outputs the header and the quantized data corresponding to the header.

Furthermore, for example, when decoding_2 (S320) on all of the macroblocks in one picture is completed, processing of S310 to S335 is performed on a subsequent picture.

FIG. 28A is a flowchart of an example of processing in decoding_1 shown in FIG. 27.

The first decoding processing unit 811 in the preceding unit 810 performs arithmetic decoding (S311) on the first coded data and the second coded data included in the stream, and measures the coding amount generated in the arithmetic decoding (S312).

When headers (first coded data) are processed (Yes in S313), the measurement result is stored as the coding amount of the headers (S314). When quantized data (second coded data) is processed (No in S313), the measurement result is stored as the coding amount of the quantized data (S315).

When the end of a header or the end of quantized data for a macroblock is processed (Yes in S316), for example, the first transfer control unit 812 performs termination processing on the end for connecting to a subsequent header or subsequent quantized data (S317).

The first transfer control unit 812 further saves the arithmetic decoded headers or arithmetic decoded quantized data in the main memory 620 (S318).

Subsequently, for example, when there is not more data to be transferred to the main memory 620 (Yes in S319), the decoding_1 ends.

FIG. 28B is a flowchart of an example of processing in decoding_2 shown in FIG. 27.

The second transfer control unit 822 in the subsequent unit 820 restores the intermediate data that is to be debinarized, from the main memory 620 (S321). More specifically, the intermediate data is obtained from the main memory 620.

The second transfer control unit 822 measures the coding amount of the obtained intermediate data (S322). When headers are to be processed (Yes in S323), the second transfer control unit 822 compares the measurement result with the total coding amount of the headers (S324). When the quantized data is to be processed (No in S323), the second transfer control unit 822 compares the measurement result with the total coding amount of the quantized data (S325).

The total coding amount is obtained by referring to the restore-transfer information c and the restore-transfer information d.

When the second transfer control unit 822 detects that the end of the header or the end of the quantized data is to be processed, from the comparison result (Yes in S326), the second transfer control unit 822 performs termination processing (S327).

The second transfer control unit 822 also inputs, to the second decoding processing unit 821, a plurality of headers for one picture and the quantized data items corresponding to the headers, for example.

The second decoding processing unit 821 performs debinarization on the input data (S328). As a result, each of the headers for the one picture and each of the quantized data items corresponding to the headers are sequentially output from the stream processing apparatus 800. For example, as described above, a pair of macroblock header #K and quantized data #K is output from the stream processing apparatus 800 in the order from K being 0, 1, 2, . . . to N.

Subsequently, for example, when there is no more data to be debinarized (Yes in S329), the decoding_2 ends.

In Embodiment 3, descriptions have been given of the case where, in the stream processing apparatus 800, the preceding unit 810 performs arithmetic decoding on the headers and quantized data, and the subsequent unit 820 performs debinarization on the headers and quantized data.

However, the preceding unit 810 and the subsequent unit 820 may share processing (arithmetic decoding and debinarization on headers and quantized data) differently.

For example, it may be that the preceding unit 810 performs arithmetic decoding and debinarization on the quantized data, and the subsequent unit 820 performs arithmetic decoding and debinarization on the headers.

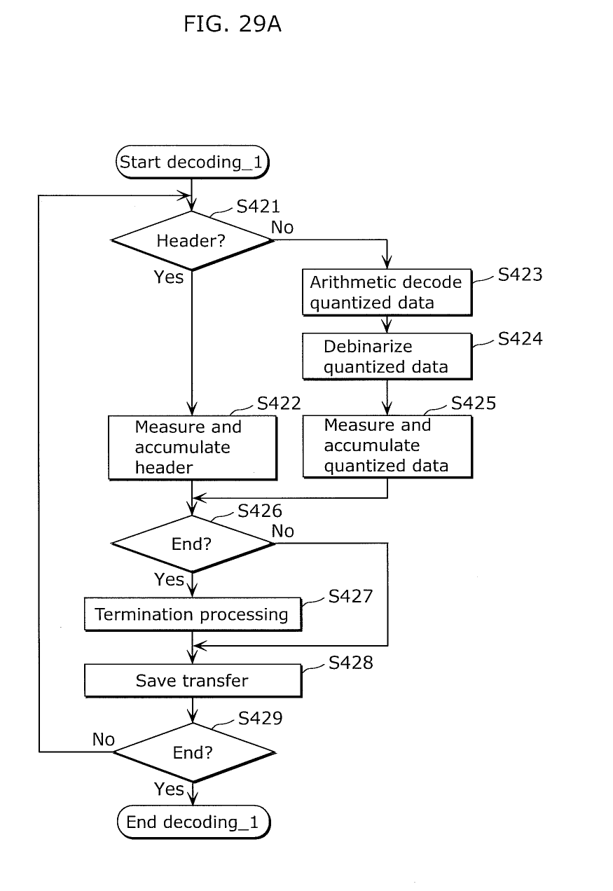

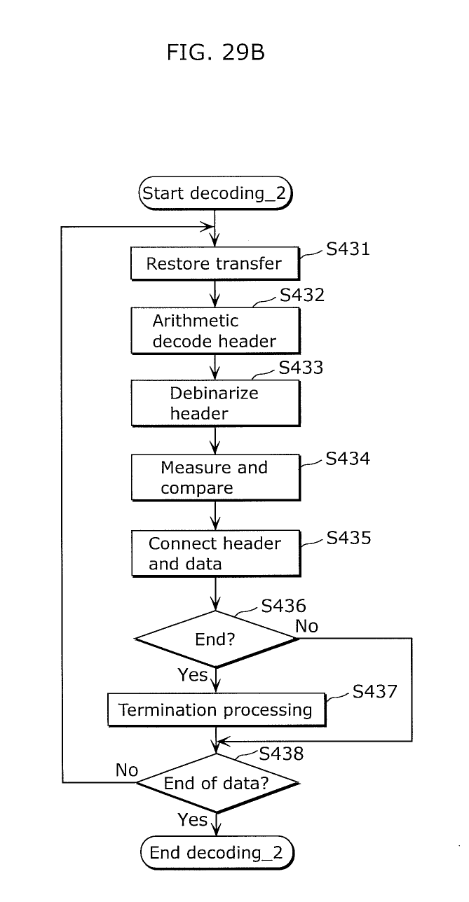

Now, referring to FIG. 29A and FIG. 29B, a description is given of an example of the processing performed by the stream processing apparatus 800 in the case where the preceding unit 810 performs arithmetic decoding and debinarization on quantized data, and the subsequent unit 820 performs arithmetic decoding and debinarization on headers.

FIG. 29A is a flowchart of another example of processing in the decoding_1 shown in FIG. 27.

When quantized data is to be processed (No in S421), the first decoding processing unit 811 in the preceding unit 810 performs arithmetic decoding and debinarization on quantized data items for a predetermined unit, such as a picture, for example, (S423 and S424), and measures and stores the coding amount of the debinarized quantized data (S425).

On the other hand, when headers are to be processed (Yes in S421), the first decoding processing unit 811 does not perform processing such as decoding, but measures and stores the coding amount of the headers (S422).

The quantized data, on which processing up to and including debinarization has been performed, and headers, on which arithmetic decoding and debinarization have not been performed, are input from the first decoding processing unit 811 to the first transfer control unit 812.

After the processing of S423 to S425 or of S422, in the case where the first transfer control unit 812 detects that the end of the header or the end of the quantized data is to be processed (Yes in S426), the first transfer control unit 812 performs termination processing on the end for connecting to a subsequent header or subsequent quantized data (S427).

Subsequently, the first transfer control unit 812 saves intermediate data, which is quantized data for a predetermined unit on which processing up to and including debinarization has been performed (second data) or headers for the predetermined unit on which arithmetic decoding and debinarization have not been performed (first data), in the main memory 620 (S428).

The save processing, that is, the transfer of the intermediate data to the main memory 620 is performed according to the save-transfer information c and the save-transfer information d (see FIG. 22).

More specifically, the first coded data is stored, by the transfer, in the first storage area as the first data. The first coded data here is the first coded data on which the first decoding processing has been performed and which is input from the first decoding processing unit 811 to the first transfer control unit 812 without arithmetic decoding and debinarization.

Furthermore, the second coded data is stored, by the transfer, in the second storage area as the second data. The second coded data here is the second coded data on which the first decoding processing has been performed and on which arithmetic decoding and debinarization have been performed.

Subsequently, for example, when there is no more data to be transferred to the main memory 620 (Yes in S429), the decoding_1 ends.

FIG. 29B is a flowchart of another example of processing in the decoding_2 shown in FIG. 27.

The second transfer control unit 822 in the subsequent unit 820 restores the intermediate data saved in the main memory 620, from the main memory 620 (S431). More specifically, the intermediate data is obtained from the main memory 620.

The restore processing, that is, the transfer of the intermediate data from the main memory 620 is performed according to the restore-transfer information c and the restore-transfer information d (see FIG. 22).

The second decoding processing unit 821 performs arithmetic decoding on the first data included in the intermediate data obtained by the second transfer control unit 822 (S432), and further performs debinarization on the arithmetic decoded first data (S433). As a result, headers which are multivalued data are obtained.

The coding amounts of respective headers and quantized data, which are multivalued data obtained by the above processing, are measured. Furthermore, each of the coding amounts of the headers and quantized data is compared with the total coding amount indicated in each of the restore-transfer information c and the restore-transfer information d (S434).

Furthermore, the header and the quantized data corresponding to the header are connected (S435).

When the second decoding processing unit 821 detects the end of the quantized data based on the result of the comparison (S434) (Yes in S436), the second decoding processing unit 821 performs termination processing for connecting the end to a subsequent header (S437).

Subsequently, for example, when there is no more data to be arithmetic decoded and debinarized (Yes in S438), the decoding_2 ends.

Each of the thus obtained headers for a predetermined unit (for example, one picture) and quantized data corresponding to the header are sequentially output from the stream processing apparatus 800. For example, as described above, a pair of macroblock header #K and quantized data #K is output from the stream processing apparatus 800 in the order from K being 0, 1, 2, . . . to N.

As described above, the stream processing apparatus 800 according to Embodiment 3 is capable of (i) restoring, into multivalued data, the headers and quantized data included in a stream to which both arithmetic coding and data partitioning have been applied, and (ii) outputting the restored data in the order of the data before the data partitioning is performed.

More specifically, it is possible to appropriately perform decoding on a stream, having both high error tolerance and high compression rate, generated by the image coding apparatus 10 according to Embodiment 1 or 2.

### Embodiment 4

Next, as Embodiment 4, a description is given of a stream processing apparatus which decodes a stream on which variable-length coding, compression coding, and data partitioning have been performed and which includes an initial header having positional information indicating the position of beginning of second coded data.

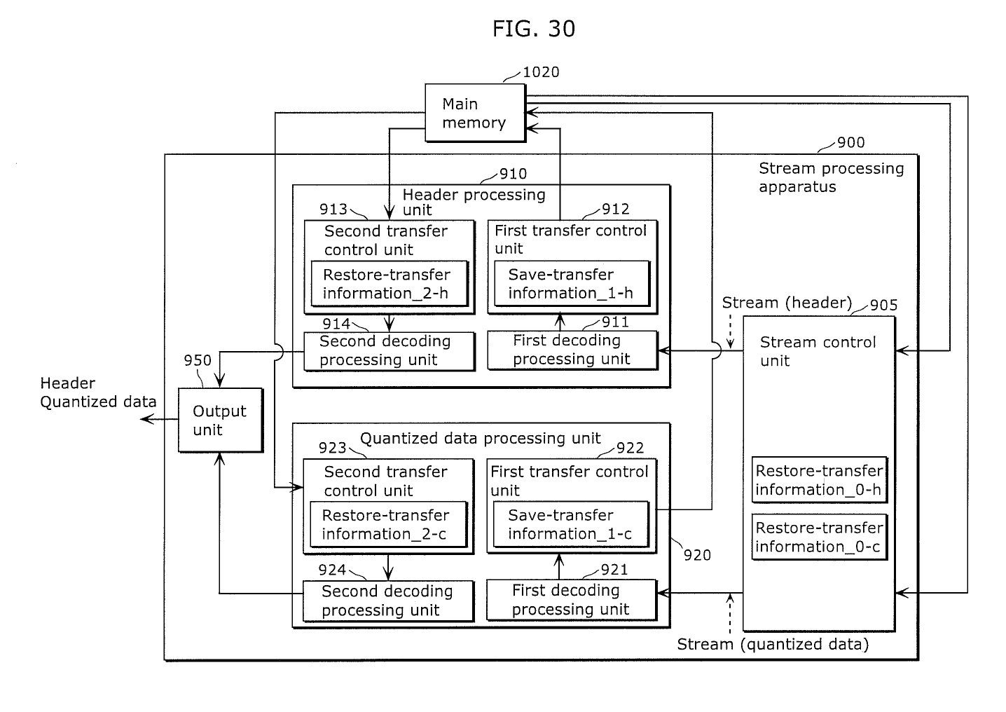

FIG. 30 is a block diagram schematically showing a configuration of a stream processing apparatus according to Embodiment 4.

A stream processing apparatus 900 shown in FIG. 30 is an apparatus which is provided instead of the stream processing apparatus 800, in the image decoding unit 700 shown in FIG. 21, for example.

More specifically, the stream processing apparatus 900 according to Embodiment 4 is an apparatus which outputs headers and quantized data restored into multivalued data, by processing a stream to which both arithmetic coding and data partitioning have been applied, in the similar manner to the stream processing apparatus 800 according to Embodiment 3.

The stream input to the stream processing apparatus 900 includes an initial header (for example, the leftmost header in FIG. 23) having positional information indicating the position of beginning of second coded data.

In the case of the stream shown in FIG. 23, the initial header includes positional information including information indicating the sum of the size of the initial header and the size of the first coded data (macroblock #0 to macroblock #N).

The stream processing apparatus 900 achieves efficient decoding by using the positional information.

The stream processing apparatus 900 includes, as shown in FIG. 30, a stream control unit 905, a header processing unit 910, a quantized data processing unit 920, and an output unit 950.

The stream processing apparatus 900 is connected to a main memory 1020. The main memory 1020 is a storage unit corresponding to the main memory 620 (see FIG. 21) connected to the image decoding unit 700.

The mapping of the storage area in the main memory 1020 according to Embodiment 4 is similar to that of the storage area in the main memory 20 according to Embodiment 1, and includes a first storage area and a second storage area (see FIG. 8).

The stream control unit 905 obtains a stream, and outputs the first coded data and the second coded data in parallel, based on the positional information read from the initial header of the stream.

More specifically, the stream control unit 905 is capable of instantly determining the position of the boundary between the first coded data and the second coded data, by referring to the positional information included in the initial header of the stream.

Specifically, the stream control unit 905 reads the positional information from the initial header in the stream temporarily stored in the main memory 1020, for example.

The stream control unit 905 further stores, as restore-transfer information_0-h, the address in a predetermined storage area in the main memory 1020 at which the first coded data is stored.

The stream control unit 905 also stores, as restore-transfer information_0-c, the address in a predetermined storage area in the main memory 1020 at which the second coded data is stored. The address is obtained using the positional information.

The stream control unit 905 reads the first coded data from the address in the main memory 1020 indicated by the restore-transfer information_0-h, and reads the second coded data from the address in the main memory 1020 indicated by the restore-transfer information_0-c.

The stream control unit 905 outputs the first coded data to the header processing unit 910 and outputs the second coded data to the quantized data processing unit 920.

More specifically, the stream control unit 905 is capable of separately obtaining the first coded data and the second coded data from the stream, without analyzing the target stream from the beginning of the stream. As a result, it is possible to output the first coded data and the second coded data in parallel.

The header processing unit 910 is an example of the first stream processing unit. The header processing unit 910 obtains headers which are in a state before variable-length coding and compression coding are performed, by performing decompression decoding and variable-length decoding on the first coded data output from the stream control unit 905.

In Embodiment 4, the header processing unit 910 obtains the headers which are in a state before binarization and arithmetic coding are performed, by performing arithmetic decoding and debinarization on the first coded data obtained by performing binarization and arithmetic coding.

More specifically, the header processing unit 910 includes a first decoding processing unit 911, a first transfer control unit 912, a second transfer control unit 913, and a second decoding processing unit 914.

In other words, the header processing unit 910 has a configuration similar to that of the stream processing apparatus 800 according to Embodiment 3. The following provides a brief description of the processing performed by the header processing unit 910.

In the header processing unit 910, the first decoding processing unit 911 performs arithmetic decoding on the first coded data. The intermediate data (first data) thus obtained is transferred to the first storage area in the main memory 1020 by the first transfer control unit 912.

The save-transfer information_1-h held in the first transfer control unit 912 is referred to for the transfer, and the first data is stored at the address in the first storage area which is set to the save-transfer information_1-h.

The second transfer control unit 913 reads the first data from the first storage area in the main memory 1020. The restore-transfer information_2-h held in the second transfer control unit 913 is referred to for the reading, and the first data is read from the address in the first storage area which is set to the restore-transfer information_2-h.

The save-transfer information_1-h and the restore-transfer information_2-h are, for example, set by the control unit 650 (see FIG. 20) which controls the operations of the image decoding unit 700 which includes the stream processing apparatus 900.

The second transfer control unit 913 transmits the first data to the second decoding processing unit 914, and the second decoding processing unit 914 performs debinarization on the received first data and sequentially outputs the headers that are multivalued data to the output unit 950.

The quantized data processing unit 920 is an example of the second stream processing unit. The quantized data processing unit 920 obtains the quantized data that is in a state before variable-length coding and compression coding are performed, by performing decompression decoding and variable-length decoding on the second coded data output from the stream control unit 905.

In Embodiment 4, the quantized data processing unit 920 obtains the quantized data that is in a state before binarization and arithmetic coding are performed, by performing arithmetic decoding and debinarization on the second coded data obtained by performing binarization and arithmetic coding.

More specifically, the quantized data processing unit 920 includes a first decoding processing unit 921, a first transfer control unit 922, a second transfer control unit 923, and a second decoding processing unit 924.

In other words, the quantized data processing unit 920 includes a configuration similar to that of the stream processing apparatus 800 according to Embodiment 3, like the header processing unit 910. The following provides a brief description of the flow of processing performed by the quantized data processing unit 920.

In the quantized data processing unit 920, the first decoding processing unit 921 performs arithmetic decoding on the second coded data. The intermediate data (second data) thus obtained is transferred to the second storage area in the main memory 1020 by the first transfer control unit 922.

The save-transfer information_1-c held in the first transfer control unit 922 is referred to for the transfer, and the second data is stored at the address in the second storage area which is set to the save-transfer information_1-c.

The second transfer control unit 923 reads the second data from the second storage area in the main memory 1020. The restore-transfer information_2-c held in the second transfer control unit 923 is referred to for the reading, and the second data is read from the address in the second storage area which is set to the restore-transfer information_2-c.

The save-transfer information_1-c and the restore-transfer information_2-c are, for example, set by the control unit 650 (see FIG. 20) which controls the operations of the image decoding unit 700 which includes the stream processing apparatus 900.

The second transfer control unit 923 transmits the second data to the second decoding processing unit 924, and the second decoding processing unit 924 performs debinarization on the received second data, and sequentially outputs the quantized data that is multivalued data to the output unit 950.

The decoding by the header processing unit 910 and the decoding by the quantized data processing unit 920 described above are performed in parallel.

More specifically, the header and the quantized data for a given macroblock (for example, the macroblock header #0 and the quantized data #0 in FIG. 23) are processed almost simultaneously.

The output unit 950 sequentially outputs the header obtained by the header processing unit 910 and the quantized data corresponding to the header obtained by the quantized data processing unit 920.

For example, when the stream shown in FIG. 23 is input to the stream processing apparatus 900, a pair of macroblock header #K and quantized data #K is output from the output unit 950 in the stream processing apparatus 900 in the order from K being 0, 1, 2, . . . , to N.

In such a manner, in the stream processing apparatus 900, the stream control unit 905 outputs the first coded data and the second coded data in parallel by referring to the positional information included in the initial header in the stream.

As a result, the stream processing apparatus 900 is capable of performing the processing for obtaining a header that is multivalued data from the first coded data, and the processing for obtaining quantized data that is multivalued data from the second coded data, in parallel.

In other words, the stream processing apparatus 900 is capable of increasing decoding efficiency of a stream to which both arithmetic coding and data partitioning have been applied.

The header processing unit 910 and the quantized data processing unit 920 temporarily store, in the main memory 1020, intermediate data (the first data or the second data) generated between the processing in the preceding unit and the processing in the subsequent unit; however, the save processing need not be performed.

For example, suppose a case where the second decoding processing unit 914 is capable of sequentially receiving, from the first decoding processing unit 911, the processing results (headers that are binary data) of arithmetic decoding performed by the first decoding processing unit 911, for debinarization. In this case, the second decoding processing unit 914 may receive the processing results of the second decoding processing unit 914 without using the main memory 1020.

Here, a description is given of a stream processing apparatus having a configuration where intermediate data generated between the preceding unit and the subsequent unit in each of the header processing unit and the quantized data processing unit is not saved in the main memory 1020.

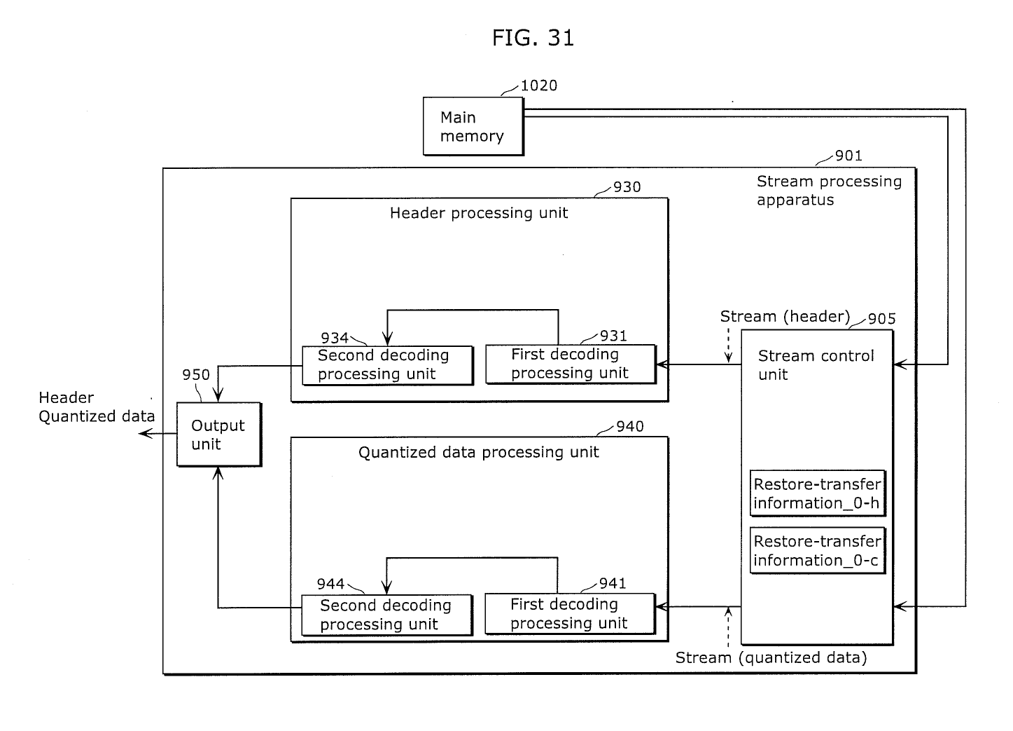

FIG. 31 is a block diagram schematically showing another example of a configuration of the stream processing apparatus according to Embodiment 4.

A stream processing apparatus 901 shown in FIG. 31 is an apparatus which outputs debinarized headers and quantized data, by processing a stream to which both arithmetic coding and data partitioning have been performed, in the similar manner to the stream processing apparatus 900. The initial header in a stream to be processed includes positional information indicating the position of beginning of second coded data.

The stream processing apparatus 901 includes a stream control unit 905, a header processing unit 930, a quantized data processing unit 940, and an output unit 950.

The stream control unit 905 obtains, as described above, first coded data and second coded data from the stream, based on the positional information. The stream control unit 905 also outputs the first coded data and the second coded data in parallel.

The header processing unit 930 includes a first decoding processing unit 931 and a second decoding processing unit 934. The first decoding processing unit 931 performs arithmetic decoding on the first coded data received from the stream control unit 905, and transmits the thus obtained headers of binary signals to the second decoding processing unit 934. The second decoding processing unit 934 performs debinarization on the received headers, and transmits the thus obtained headers that is multivalued data, to the output unit 950.

The quantized data processing unit 940 includes a first decoding processing unit 941 and a second decoding processing unit 944. The first decoding processing unit 941 performs arithmetic decoding on the second coded data received from the stream control unit 905, and transmits the thus obtained quantized data that is binary data to the second decoding processing unit 944. The second decoding processing unit 944 performs debinarization on the received quantized data, and transmits the thus obtained quantized data that is multivalued data to the output unit 950.

The decoding by the header processing unit 930 and the decoding by the quantized data processing unit 940 are performed in parallel.

More specifically, the header and the quantized data for a given macroblock (for example, the macroblock header #0 and the quantized data #0 in FIG. 23) are processed almost simultaneously.

The output unit 950 sequentially outputs the header obtained by the header processing unit 930 and the quantized data corresponding to the header obtained by the quantized data processing unit 940.

For example, when the stream shown in FIG. 23 is input to the stream processing apparatus 901, a pair of macroblock header #K and quantized data #K is output from the output unit 950 in the stream processing apparatus 900 in the order from K being 0, 1, 2, . . . to N.

As described above, each of the stream processing apparatus 900 and 901 according to Embodiment 4 is capable of easily determining the position of the boundary between a set of headers (first coded data) and a set of quantized data items (second coded data) included in the stream, by reading the positional information included in the initial header of the stream. This allows the first coded data and the second coded data included in the stream, to which both arithmetic coding and data partitioning are applied, to be easily and instantly obtained. As a result, it is possible to perform decoding on the first coded data and the second coded data in parallel.

More specifically, each of the stream processing apparatuses 900 and 901 is capable of appropriately and efficiently decoding a stream having high error tolerance and high compression rate generated by the image coding apparatus 10 according to Embodiment 1 or 2.

Descriptions have been given of the stream generation apparatus and the stream generation method according to the present invention based on Embodiment 3 and Embodiment 4, However, the present invention is not limited to such embodiments and the supplemental note thereof.

Those skilled in the art will readily appreciate that various modifications may be made in these exemplary embodiments without materially departing from the principles and spirit of the inventive concept, the scope of which is defined in the appended Claims and their equivalents.

For example, as described in Embodiment 1, when intermediate data is saved, the intermediate data may be stored in the main memory 620 or 1020 in such a manner that one header or one quantized data item is stored in successive words.

More specifically, focusing on a given header included in the first data, the first data may be transferred to the first storage area to allow at least part of the header and at least part of another header to be successively stored in one word in the first storage area.

The same also applies to the second data. More specifically, it may be that the second data is transferred to the second storage area to allow at least part of a given quantized data item and at least part of another quantized data item to be successively stored in one word in the second storage area.

By storing intermediate data in each of the first storage area and the second storage area in succession in such a manner, the storage capacity of the first storage area and the second storage area efficiently used.

Furthermore, it may be that the first storage area and the second storage area according to Embodiments 3 and 4 are present in physically different memories as described in Embodiment 1.

More specifically, it may be that the first transfer control unit 812 and the first transfer control unit 912 transfer the first data to the first storage area in a first memory in the storage unit to store the first data in the first storage area.

Furthermore, it may be that the first transfer control unit 812 and the first transfer control unit 922 transfer the second data to the second storage area in a second memory that is physically different from the first memory and that is included in the storage unit, to store the second data in the second storage area.

Furthermore, in Embodiments 3 and 4, arithmetic decoding and debinarization are used as decoding performed in two stages (decompression decoding and variable-length decoding). However, the present invention is not limited to the example.

For example, one or more exemplary embodiments or features disclosed herein is applicable to an apparatus which performs decoding in two stages on a stream generated by coding in which processing after quantization is performed in two stages. In the coding, variable-length data is provided by the preceding stage, and a predetermined amount of variable-length data is collectively compressed in the subsequent stage. The decoding corresponds to the coding.

Furthermore, an apparatus which includes the stream processing apparatus 800, 900, or 901 according to Embodiments 3 and 4 is not particularly limited. Each of the stream processing apparatuses 800, 900, and 901 may be included in the image decoding unit 514 in the AV system 500 shown in FIG. 18, for example, as an apparatus which restores headers and quantized data from a stream obtained by arithmetic coding into multivalued data.

Furthermore, part or all of the constituent elements of each of the stream generation apparatuses 200 and 400, and the stream processing apparatuses 800, 900, and 901 according to Embodiments 1 to 4 (hereinafter, referred to as each apparatus) may be configured by a hardware. Part or all of the constituent elements of each apparatus may be a module of a program executed by a CPU or the like.

Furthermore, part or all of the constituent elements of each apparatus may be configured from a single system large scale integration (LSI).

The System LSI is a super-multi-function LSI manufactured by integrating constituent elements on one chip, and is specifically a computer system configured by including a microprocessor, a read only memory (ROM), a random access memory (RAM), and so on.

Furthermore, one or more exemplary embodiments or features disclosed herein may be implemented as a stream generation method or a stream processing method including the operations of the characteristic units included in each apparatus. Furthermore, one or more exemplary embodiments or features disclosed herein may be implemented as a program causing a computer to execute each step included in the stream generation method or the stream processing method.

Furthermore, one or more exemplary embodiments or features disclosed herein may be implemented as a computer-readable recording medium storing such a program. Such a program may be distributed via a transmission medium such as the Internet.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

One or more exemplary embodiments disclosed herein provide a stream generation apparatus and a stream generation method which generate a stream having both high error tolerance and high compression rate while reducing overhead such as transfer bandwidth or implementation circuits. Hence, one or more exemplary embodiments disclosed herein are useful as a stream generation apparatus and the like which is included in an apparatus which performs compression coding on image data for output.

Furthermore, one or more exemplary embodiments disclosed herein provides a stream processing apparatus and a stream processing method which decode a stream having both high error tolerance and high compression rate. Hence, one or more exemplary embodiments disclosed herein are useful as a stream processing apparatus and the like which is included in an apparatus which performs decompression decoding on image data for output.

1. A stream generation apparatus which (i) receives a quantized data item which is a quantized image data item and a header corresponding to the quantized data item and (ii) generates a stream by performing variable-length coding and compression coding in this order on the received header and the received quantized data item, the stream generation apparatus comprising:
a first processing unit configured to perform first processing on the received header and the received quantized data item, the first processing including at least the variable-length coding on the header;
a first transfer control unit configured to transfer the header on which the first processing has been performed to a first storage area in a storage unit connected to the stream generation apparatus, and to transfer the quantized data item on which the first processing has been performed to a second storage area in the storage unit;
a second transfer control unit configured to (i) obtain, from the first storage area, a plurality of the headers which are for a predetermined unit and on which the first processing has been performed, and (ii) obtain, from the second storage area, a plurality of the quantized data items which are for the predetermined unit and on which the first processing has been performed; and
a second processing unit configured to perform second processing on the obtained headers and the obtained quantized data items which are for the predetermined unit and on which the first processing has been performed, the second processing including at least the compression coding on the quantized data items which are for the predetermined unit and on which the first processing has been performed,
wherein the second processing unit is configured to generate a stream including first coded data followed by second coded data, the first coded data being the headers which are for the predetermined unit and which are obtained by the first processing and the second processing, the second coded data being the quantized data items which are for the predetermined unit and which are obtained by the first processing and the second processing.

2. The stream generation apparatus according to claim 1,
wherein the first processing unit is configured to generate a variable-length coded header which is the header on which the variable-length coding has been performed and a variable-length coded quantized data item which is the quantized data item on which the variable-length coding has been performed, by performing the first processing which is the variable-length coding on the received header and the received quantized data item,
the first transfer control unit is configured to transfer the variable-length coded header to the first storage area, and to transfer the variable-length coded quantized data item to the second storage area,
the second transfer control unit is configured to obtain the variable-length coded headers for the predetermined unit from the first storage area, and to obtain the variable-length coded quantized data items for the predetermined unit from the second storage area, and
the second processing unit is configured to generate the stream using the first coded data and the second coded data which are obtained by performing the second processing which is the compression coding on the obtained variable-length coded headers for the predetermined unit and the obtained variable-length coded quantized data items for the predetermined unit.

3. The stream generation apparatus according to claim 1,
wherein the first processing unit is configured to perform the first processing including (i) the variable-length coding and the compression coding on the received header and (ii) inputting the received quantized data item to the first transfer control unit,
the first transfer control unit is configured to transfer the header on which the variable-length coding and the compression coding have been performed to the first storage area, and to transfer the input quantized data item to the second storage area,
the second transfer control unit is configured to obtain, from the first storage area, the headers which are for the predetermined unit and on which the variable-length coding and the compression coding have been performed, and to obtain the quantized data items for the predetermined unit from the second storage area, and
the second processing unit is configured to generate the stream using the first coded data and the second coded data which are obtained by the second processing including (i) receiving the obtained headers for the predetermined unit from the second transfer control unit and (ii) the variable-length coding and the compression coding on the obtained quantized data items for the predetermined unit.

4. The stream generation apparatus according to claim 1,
wherein, when transferring the header on which the first processing has been performed to the first storage area, the first transfer control unit is configured to transfer the header to allow at least part of the header and part of an other header to be successively stored in one word in the first storage area, and
when transferring the quantized data item on which the first processing has been performed to the second storage area, the first transfer control unit is configured to transfer the quantized data item to allow at least part of the quantized data item and part of an other quantized data item to be successively stored in one word in the second storage area.

5. The stream generation apparatus according to claim 1,
wherein the first transfer control unit includes first address information and second address information which are referred to when transferring the header and the quantized data item, the first address information indicating an address in the first storage area at which the header, on which the first processing has been performed and which is transferred by the first transfer control unit, is stored, the second address information indicating an address in the second storage area at which the quantized data item, on which the first processing has been performed and which is transferred by the first transfer control unit, is stored.

6. The stream generation apparatus according to claim 1,
wherein the first transfer control unit is configured to (i) transfer the header on which the first processing has been performed to the first storage area in a first memory in the storage unit, to store the header in the first storage area, and (ii) transfer the quantized data item on which the first processing has been performed to the second storage area in a second memory in the storage unit, to store the quantized data item in the second storage area, the second memory being physically different from the first memory.

7. The stream generation apparatus according to claim 1,
wherein the first transfer control unit is configured to (i) transfer the header on which the first processing has been performed to the first storage area in a memory in the storage unit, to store the header in the first storage area, and (ii) transfer the quantized data item on which the first processing has been performed to the second storage area in the memory, to store the quantized data item in the second storage area.

8. The stream generation apparatus according to claim 1,
wherein the second transfer control unit is configured to obtain, from the first storage area, the headers which are for one picture and on which the first processing has been performed, and to obtain, from the second storage area, the quantized data items which are for the one picture and on which the first processing has been performed, the one picture being the predetermined unit, and
the second processing unit is configured to perform the second processing on the obtained headers for the one picture and the obtained quantized data items for the one picture, and to generate a stream including the first coded data for the one picture followed by the second coded data for the one picture.

9. A stream generation method of receiving a quantized data item which is a quantized image data item and a header corresponding to the quantized data item and generating a stream by performing variable-length coding and compression coding in this order on the received header and the received quantized data item, the stream generation method comprising:
performing first processing on the received header and the received quantized data item, the first processing including at least the variable-length coding on the header;
transferring the header on which the first processing has been performed to a first storage area in a storage unit, and transferring the quantized data item on which the first processing has been performed to a second storage area in the storage unit;
obtaining, from the first storage area, a plurality of the headers which are for a predetermined unit and on which the first processing has been performed, and obtaining, from the second storage area, a plurality of the quantized data items which are for the predetermined unit and on which the first processing has been performed;
performing second processing on the obtained headers and the obtained quantized data items which are for the predetermined unit and on which the first processing has been performed, the second processing including at least the compression coding on the quantized data items which are for the predetermined unit and on which the first processing has been performed; and
generating a stream including first coded data followed by second coded data, the first coded data being the headers which are for the predetermined unit and which are obtained by the first processing and the second processing, the second coded data being the quantized data items which are for the predetermined unit and which are obtained by the first processing and the second processing.

10. An integrated circuit which receives a quantized data item which is a quantized image data item and a header corresponding to the quantized data item and generates a stream by performing variable-length coding and compression coding in this order on the received header and the received quantized data item, the integrated circuit comprising:
a first processing unit configured to perform first processing on the received header and the received quantized data item, the first processing including at least the variable-length coding on the header;
a first transfer control unit configured to transfer the header on which the first processing has been performed to a first storage area in a storage unit connected to the integrated circuit, and to transfer the quantized data item on which the first processing has been performed to a second storage area in the storage unit;
a second transfer control unit configured to (i) obtain, from the first storage area, a plurality of the headers which are for a predetermined unit and on which the first processing has been performed, and (ii) obtain, from the second storage area, a plurality of the quantized data items on which the first processing has been performed; and
a second processing unit configured to perform second processing on the obtained headers and the obtained quantized data items which are for the predetermined unit and on which the first processing has been performed, the second processing including at least the compression coding on the quantized data items which are for the predetermined unit and on which the first processing has been performed,
wherein the second processing unit is configured to generate a stream including first coded data followed by second coded data, the first coded data being the headers which are for the predetermined unit and which are obtained by the first processing and the second processing, the second coded data being the quantized data items which are for the predetermined unit and which are obtained by the first processing and the second processing.

11. A stream processing apparatus which decodes a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit, the stream processing apparatus comprising:
a first decoding processing unit configured to perform first decoding processing on the stream, the first decoding processing including at least decompression decoding on the second coded data;
a first transfer control unit configured to (i) transfer first data which is the first coded data on which the first decoding processing has been performed, to a first storage area in a storage unit connected to the stream processing apparatus, and (ii) transfer second data which is the second coded data on which the first decoding processing has been performed, to a second storage area in the storage unit;
a second transfer control unit configured to (i) obtain the first data from the first storage area, and obtain the second data from the second storage area, and (ii) output each of the headers on which the first decoding processing has been performed and the quantized data item which corresponds to the header and on which the first decoding processing has been performed, the header and the quantized data item being respectively included in the first data and the second data; and
a second decoding processing unit configured to perform second decoding processing on the header and the quantized data item on which the first decoding processing has been performed, the header and the quantized data item being output from the second transfer control unit, the second decoding processing including at least variable length decoding on the header,
wherein the second decoding processing unit is configured to successively output the header and the quantized data item corresponding to the header which are obtained by the first decoding processing and the second decoding processing, the header and the quantized data item being in a state before the variable-length coding and the compression coding are performed.

12. The stream processing apparatus according to claim 11,
wherein the first decoding processing unit is configured to generate the first data and the second data by performing the first decoding processing which is the decompression decoding on the first coded data and the second coded data, and
the second decoding processing unit is configured to generate the header and the quantized data item in a state before the variable-length coding and the compression coding are performed, by performing the second decoding processing which is the variable-length decoding on the header and the quantized data item on which the decompression decoding has been performed.

13. The stream processing apparatus according to claim 11,
wherein the first decoding processing unit is configured to perform the first decoding processing including (I) the decompression decoding and the variable-length decoding on the second coded data and (ii) inputting the first coded data to the first transfer control unit,
the first transfer control unit is configured to (i) transfer, to the first storage area, the first coded data input from the first decoding processing unit, and (ii) transfer the second coded data on which the decompression decoding and the variable-length decoding have been performed to the second storage area, the first coded data being the first data, the second coded data being the second data,
the second transfer control unit is configured to output each of the headers on which the decompression decoding and the variable-length decoding have been performed and the quantized data item which corresponds to the header and on which the compression decoding and the variable-length decoding have not been performed, the header and the quantized data item being respectively included in the obtained first data and the obtained second data, and
the second decoding processing unit is configured to generate the header and the quantized data item which are in a state before the variable-length coding and the compression coding are performed, by performing the second decoding processing including (i) receiving the header on which the decompression decoding and the variable-length decoding have been performed from the second transfer control unit and (ii) performing the decompression decoding and the variable-length decoding on the quantized data item output from the second transfer control unit.

14. The stream processing apparatus according to claim
wherein, when transferring the first data to the first storage area, the first transfer control unit is configured to transfer the first data to allow at least part of one header and part of an other header which are included in the first data to be successively stored in one word in the first storage area, and
when transferring the second data to the second storage area, the first transfer control unit is configured to transfer the second data to allow at least part of one quantized data item and part of an other quantized data item which are included in the second data to be successively stored in one word in the second storage area.

15. The stream processing apparatus according to claim 11,
wherein the first transfer control unit includes first address information and second address information which are referred to when transferring the first data and the second data, the first address information indicating an address in the first storage area at which the first data transferred from the first transfer control unit is stored, the second address information indicating an address in the second storage area at which the second data transferred from the first transfer control unit is stored.

16. The stream processing apparatus according to claim 11,
wherein the first transfer control unit is configured to (i) transfer the first data to the first storage area in a first memory in the storage unit, to store the first data in the first storage area, and (ii) transfer the second data to the second storage area in a second memory in the storage unit, to store the second data in the second storage area, the second memory being physically different from the first memory.

17. The stream processing apparatus according to claim 11,
wherein the first transfer control unit is configured to (i) transfer the first data to the first storage area in a memory in the storage unit, to store the first data in the first storage area, and (ii) transfer the second data to the second storage area in the memory, to store the second data in the second storage area.

18. The stream processing apparatus according to claim 11,
wherein the first decoding processing unit is configured to perform the first decoding processing on the first coded data which is the headers for one picture and the second coded data which is the quantized data items for the one picture, the one picture being the predetermined unit, and
the first transfer control unit is configured to (i) transfer, to the first storage area, the first data including the headers which are for the one picture and on which the first decoding processing has been performed and (ii) transfer, to the second storage area, the second data including the quantized data items which are for the one picture and on which the first decoding processing has been performed.

19. A stream processing method of decoding a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit, the stream processing method comprising:
performing first decoding processing on the stream, the first decoding processing including at least decompression decoding on the second coded data;
transferring first data which is the first coded data on which the first decoding processing has been performed to a first storage area in a storage unit, and transferring second data which is the second coded data on which the first decoding processing has been performed to a second storage area in the storage unit;
obtaining the first data from the first storage area and the second data from the second storage area, and outputting each of the headers on which the first decoding processing has been performed and the quantized data item which corresponds to the header and on which the first decoding processing has been performed; the header and the quantized data item being respectively included in the obtained first data and the obtained second data;
performing second decoding processing on the header and the quantized data item on which the first decoding processing has been performed, the header and the quantized data item being output in the outputting, the second decoding processing including at least variable-length decoding on the header; and
outputting the header and the quantized data item corresponding to the header which are obtained by the first decoding processing and the second decoding processing, the header and the quantized data item being in a state before the variable-length coding and the compression coding are performed.

20. An integrated circuit which decodes a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit, the integrated circuit comprising:
a first decoding processing unit configured to perform first decoding processing on the stream, the first decoding processing including at least decompression decoding on the second coded data;
a first transfer control unit configured to (i) transfer first data which is the first coded data on which the first decoding processing has been performed, to a first storage area in a storage unit connected to the integrated circuit, and (ii) transfer second data which is the second coded data on which the first decoding processing has been performed to a second storage area in the storage unit;
a second transfer control unit configured to (i) obtain the first data from the first storage area, and obtain the second data from the second storage area, and (ii) output each of the headers on which the first decoding processing has been performed and the quantized data item which corresponds to the header and on which the first decoding processing has been performed, the header and the quantized data item being respectively included in the first data and the second data; and
a second decoding processing unit configured to perform second decoding processing on the header and the quantized data item on which the first decoding processing has been performed, the header and the quantized data item being output from the second transfer control unit, the second decoding processing including at least variable-length decoding on the header,
wherein the second decoding processing unit is configured to successively output the header and the quantized data item corresponding to the header which are obtained by the first decoding processing and the second decoding processing, the header and the quantized data item being in a state before the variable-length coding and the compression coding are performed.

21. A stream processing apparatus which decodes a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit, the stream including an initial header including positional information indicating a position of beginning of the second coded data in the stream, the stream processing apparatus comprising:
a stream control unit configured to obtain the stream, and to output the first coded data and the second coded data in parallel, based on the positional information read from the initial header in the stream;
a first stream processing unit configured to obtain the header in a state before the variable-length coding and the compression coding are performed, by performing decompression decoding and variable-length decoding on the first coded data output from the stream control unit;
a second stream processing unit configured to obtain the quantized data item in a state before the variable-length coding and the compression coding are performed, by performing the decompression decoding and the variable-length decoding on the second coded data output from the stream control unit; and
an output unit configured to successively output the header obtained by the first stream processing unit and the quantized data item corresponding to the header and obtained by the second stream processing unit.

22. A stream processing method of decoding a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit, the stream including an initial header including positional information indicating a position of beginning of the second coded data in the stream, the stream processing method comprising:
obtaining the stream, and outputting the first coded data and the second coded data in parallel, based on the positional information read from the initial header in the stream;
obtaining the header in a state before the variable-length coding and the compression coding are performed, by performing decompression decoding and variable-length decoding on the first coded data output in the outputting of the first coded data and the second coded data;
obtaining the quantized data item in a state before the variable-length coding and the compression coding are performed, by performing the decompression decoding and the variable-length decoding on the second coded data output in the outputting of the first coded data and the second coded data; and
successively outputting the header obtained in the obtaining of the header and the quantized data item corresponding to the header and obtained in the obtaining of the quantized data item.

23. An integrated circuit which decodes a stream generated by variable-length coding and compression coding performed in this order on a quantized data item which is a quantized image data item and a header corresponding to the quantized data item, the stream including first coded data followed by second coded data, the first coded data being a plurality of the headers for a predetermined unit, the second coded data being a plurality of the quantized data items for the predetermined unit, the stream including an initial header including positional information indicating a position of beginning of the second coded data in the stream, the integrated circuit comprising:
a stream control unit configured to obtain the stream, and to output the first coded data and the second coded data in parallel, based on the positional information read from the initial header in the stream;
a first stream processing unit configured to obtain the header in a state before the variable-length coding and the compression coding are performed, by performing decompression decoding and variable-length decoding on the first coded data output from the stream control unit;
a second stream processing unit configured to obtain the quantized data item in a state before the variable-length coding and the compression coding are performed, by performing the decompression decoding and the variable-length decoding on the second coded data output from the stream control unit; and
an output unit configured to successively output the header obtained by the first stream processing unit and the quantized data item corresponding to the header and obtained by the second stream processing unit.
